(19) United States
(12) Patent Application Publication
(10) Pub. No.: US 2011/0168938 A1
(43) Pub. Date: Jul. 14, 2011

(54) MULTIPLE INORGANIC COMPOUND AND USE THEREOF, AND METHOD OF PRODUCING MULTIPLE INORGANIC COMPOUND

(75) Inventors: Shogo ESAKI, Osaka-shi (JP); Motoaki NISHIJIMA, Osaka-shi (JP); Takeshi YAO, Kyoto-shi (JP); Mitsuhiro HIBINO, Kyoto-shi (JP)

(73) Assignee: SHARP KABUSHIKI KAISHA, Osaka (JP)

(21) Appl. No.: 12/985,634

(22) Filed: Jan. 6, 2011

(30) Foreign Application Priority Data
Jan. 8, 2010 (JP) 2010-003385

(51) Int. Cl. H01F 1/04; H01M 4/86; C09K 5/00

(52) U.S. Cl. 252/62.55; 252/182.1; 252/71

(57) ABSTRACT

An multiple inorganic compound (1) according to the present invention is a multiple inorganic compound (1) including a main crystalline phase (2) including an inorganic compound, the main crystalline phase (2) including a sub crystalline phase (3) having an elementary composition different from that of the main crystalline phase (2) however including a non-metallic element arrangement identical to that of the main crystalline phase 2. Furthermore, each of the main crystalline phase (2) and the sub crystalline phase (3) include at least one metallic element, and the at least one of the metallic element included in the sub crystalline phase (3) is identical to a metallic element included in the main crystalline phase (2), which metallic element identical to that included in the sub crystalline phase is formed as a solid solution in the main crystalline phase (2).

This Nonprovisional application claims priority under 35 U.S.C. §119(a) on Patent Application No. 2010-003385 filed in Japan on Jan. 8, 2010, the entire contents of which are hereby incorporated by reference.

### TECHNICAL FIELD

The present invention relates to a multiple inorganic compound and its use, and to a method of producing the multiple inorganic compound.

### BACKGROUND ART

Multiple inorganic compounds have been used conventionally in various fields, and these have been widely utilized. Among the multiple inorganic compounds, particularly multiple oxides such as LiCoO₂ and LiMn₂O₄ are used as cathode active material of nonaqueous electrolyte secondary batteries, for example (see Patent Literatures 1 to 4 and Non Patent Literature 1). Moreover, multiple oxides containing cobalt such as NaCoO₂ have been used as thermoelectric converting material, and further Zn—Mn ferrite has been used as magnetic material.

Examples of methods to produce the multiple oxides include a solid phase method and a hydrothermal method, and various multiple oxides are producible by these methods. Moreover, with these materials, proposals have been made to: provide a coating on a surface of the oxides to improve its performance (Patent Literatures 1 to 4 and Non Patent Literature 1); have a layered crystalline structure (Patent Literature 5 and 6); adjust a baking temperature (Patent Literature 7); or control orientation of a crystallographic axis (Patent Literature 8).

### CITATION LIST

Patent Literature 1
Japanese Patent Application Publication, Tokukai, No. 2000-231919 A (Publication Date: Aug. 22, 2000)
Patent Literature 2
Japanese Patent Application Publication, Tokukaihei, No. 9-265984 A (Publication Date: Oct. 7, 1997)
Patent Literature 3
Japanese Patent Application Publication, Tokukai, No. 2001-176513 A (Publication Date: Jun. 29, 2001)
Patent Literature 4
Japanese Patent Application Publication, Tokukai, No. 2003-272631 A (Publication Date: Sep. 26, 2003)
Patent Literature 5
Japanese Patent Application Publication, Tokukai, No. 2005-93450 A (Publication Date: Apr. 7, 2005)
Patent Literature 6
Japanese Patent Application Publication, Tokukai, No. 2004-363576 A (Publication Date: Dec. 24, 2004)
Patent Literature 7
Japanese Patent Application Publication, Tokukai, No. 2002-203994 A (Publication Date: Jul. 19, 2002)
Patent Literature 8
Japanese Patent Application Publication, Tokukai, No. 2000-269560 A (Publication Date: Sep. 29, 2000)
Non Patent Literature 1
Mitsuhiro Hibino, Masayuki Nakamura, Yuji Kamitaka, Naoshi Ozawa and Takeshi Yao, “Solid State Ionics” Volume 177, Issues 26-32, Oct. 31, 2006, Pages 2653-2656.

### SUMMARY OF INVENTION

### Technical Problem

However, although the conventional technique allows producing various multiple oxides, it is often the case that a multiple oxide having a desired function cannot be obtained.

For instance, in a case where LiMn₂O₄ is used as a cathode active material of a nonaqueous electrolyte secondary battery, manganese solves out from LiMn₂O₄ when charging and discharging the secondary battery. Mn thus solved out is separated on an anode as a metal Mn, in the charging and discharging process. The metal Mn that is separated on the anode reacts with lithium ions contained in an electrolytic solution. This as a result causes a remarkable decrease in battery capacity. In order to solve the problem, attempts have been made to coat a surface of the multiple oxide. For example, in a case where the multiple oxide is coated with an insulating body, electric resistance on the surface of the multiple oxide remarkably increases. This causes other problems such as a decrease in output characteristics of the battery. Consequently, no conclusion has been met to solve the separation of the metal Mn.

Moreover, as the thermoelectric conversion material, a single crystal of NaCoO₂ for example is used. NaCoO₂ has both a CoO₂ layer and a Na layer formed, and anisotropy generates between a parallel direction and perpendicular direction to the CoO₂ layer. Thermoelectromotive force and thermal conductivity of the NaCoO₂ single crystal is not so dependent on the layered structure, however an electric conductivity largely differs between the parallel direction and perpendicular direction to the CoO₂ layer. Therefore, the NaCoO₂ single crystal cannot be used as a practical thermoelectric conversion material, and requires further modification.

Moreover, as magnetic material, Zn—Mn ferrite for example is used as transformer core material. Zn—Mn ferrite has a large number of stratifications in a stratified core, and the thinner a thickness the more an eddy current is reduced. However, the stratification process is complex and hence is becoming a problem. Therefore, a multiple oxide that can overcome this problem has been yearned for.

The present invention is accomplished in view of the foregoing problems by focusing on achieving a drastically new design of a multiple inorganic compound including a multiple oxide, and its object is to provide a multiple inorganic compound having a new configuration.

### Solution to Problem

In order to attain the object, a multiple inorganic compound according to the present invention includes: a main crystalline phase including an inorganic compound, the main crystalline phase including a layer-shaped sub crystalline phase, the sub crystalline phase being different in elementary composition from that of the main crystalline phase however including a non-metallic element arrangement identical to that of the main crystalline phase, each of the main crystalline phase and the sub crystalline phase including at least one metallic element, at least one of the metallic element included in the sub crystalline phase being identical to a metallic element included in the main crystalline phase, the metallic element identical to that included in the sub crystalline phase being formed as a solid solution in the main crystalline phase.

According to the configuration of the multiple inorganic compound, a main crystalline phase and a sub crystalline phase has an isomorphous non-metallic element arrangement, thereby making it possible to bond the sub crystalline phase and the main crystalline phase with good affinity, via the isomorphous non-metallic element arrangement. Hence, the sub crystalline phase can stably be present on a grain boundary and interface of the main crystalline phase. Not just that, but furthermore, the metallic element is formed as a solid solution in both the main crystalline phase and the sub crystalline phase; the main crystalline phase and the sub crystalline phase has high affinity as a result, and thus a layer-shaped sub crystalline phase is present in the main crystalline phase.

Moreover, a cathode active material according to the present invention for use in a nonaqueous secondary battery includes: a multiple inorganic compound including a main crystalline phase including an inorganic compound, the main crystalline phase including a layer-shaped sub crystalline phase, the sub crystalline phase being different in elementary composition from that of the main crystalline phase however including a non-metallic element arrangement identical to that of the main crystalline phase, each of the main crystalline phase and the sub crystalline phase including at least one metallic element, at least one of the metallic element included in the sub crystalline phase being identical to a metallic element included in the main crystalline phase, the metallic element identical to that included in the sub crystalline phase being formed as a solid solution in the main crystalline phase.

According to the configuration, a new cathode active material of a nonaqueous secondary battery is provided, which cathode active material includes a multiple inorganic compound having the foregoing configuration.

Moreover, a thermoelectric conversion material according to the present invention includes: a multiple inorganic compound including a main crystalline phase including an inorganic compound, the main crystalline phase including a layer-shaped sub crystalline phase, the sub crystalline phase being different in elementary composition from that of the main crystalline phase however including a non-metallic element arrangement identical to that of the main crystalline phase, each of the main crystalline phase and the sub crystalline phase including at least one metallic element, at least one of the metallic element included in the sub crystalline phase being identical to a metallic element included in the main crystalline phase, the metallic element identical to that included in the sub crystalline phase being formed as a solid solution in the main crystalline phase.

According to the configuration, it is possible to provide a new thermoelectric conversion material that includes a multiple inorganic compound having the foregoing configuration.

Moreover, a magnetic material according to the present invention includes: a multiple inorganic compound including a main crystalline phase including an inorganic compound, the main crystalline phase including a layer-shaped sub crystalline phase, the sub crystalline phase being different in elementary composition from that of the main crystalline phase however including a non-metallic element arrangement identical to that of the main crystalline phase, each of the main crystalline phase and the sub crystalline phase including at least one metallic element, at least one of the metallic element included in the sub crystalline phase being identical to a metallic element included in the main crystalline phase, the metallic element identical to that included in the sub crystalline phase being formed as a solid solution in the main crystalline phase.

According to the configuration, it is possible to provide a new magnetic material that includes a multiple inorganic compound having the foregoing configuration.

Moreover, a method according to the present invention of producing a multiple inorganic compound includes: baking (a) a main crystalline phase raw material included in the multiple inorganic compound, the main crystalline phase raw material making up a main crystalline phase including an inorganic compound, with (b) a compound including at least one type of metallic element that is formable as a solid solution in the main crystalline phase or a simple substance of the metallic element, to produce a multiple inorganic compound wherein the main crystalline phase includes a layer-shaped sub crystalline phase, the sub crystalline phase being different in elementary composition from that of the main crystalline phase however including a non-metallic element arrangement identical to that of the main crystalline phase, each of the main crystalline phase and the sub crystalline phase including at least one metallic element, at least one of the metallic element included in the sub crystalline phase being identical to a metallic element included in the main crystalline phase, the metallic element identical to that included in the sub crystalline phase being formed as a solid solution in the main crystalline phase.

This method bakes a compound including a metallic element that is present in the main crystalline phase or a simple substance of the metallic element, with the main crystalline phase raw material. As a result, a main crystalline phase generated from the main crystalline phase raw material is caused to include the metallic element, and a sub crystalline phase generated from the main crystalline phase raw material and the compound or simple substance also is caused to include the same metallic element.

Furthermore, the main crystalline phase and sub crystalline phase have identical non-metallic element arrangements. This allows the main crystalline phase and sub crystalline phase to be present with good affinity, thereby making it possible to produce a multiple inorganic compound in which a layer-shaped sub crystalline phase is included in the main crystalline phase.

### Advantageous Effects of Invention

A multiple inorganic compound according to the present invention is one which the main crystalline phase includes a layer-shaped sub crystalline phase, the sub crystalline phase being different in elementary composition from that of the main crystalline phase however including a non-metallic element arrangement identical to that of the main crystalline phase, each of the main crystalline phase and the sub crystalline phase including at least one metallic element, at least one of the metallic element included in the sub crystalline phase being identical to a metallic element included in the main crystalline phase, and the metallic element identical to that included in the sub crystalline phase being formed as a solid solution in the main crystalline phase.

Hence, the configuration allows bonding the sub crystalline phase and the main crystalline phase with good affinity, by use of the identical non-metallic element arrangement. Furthermore, the metallic element is formed as a solid solution in both the main crystalline phase and the sub crystalline phase. With both these configurations, the layer-shaped sub crystalline phase is stably present in the main crystalline phase. This attains an effect that a new multiple inorganic compound including these configurations can be provided.

Moreover, a method according to the present invention of producing a multiple inorganic compound is a method including: baking (a) a main crystalline phase raw material included in the multiple inorganic compound, the main crystalline phase raw material making up a main crystalline phase including an inorganic compound, with (b) a compound including at least one type of metallic element that is formable as a solid solution in the main crystalline phase or a simple substance of the metallic element, to produce a multiple inorganic compound wherein the main crystalline phase includes a layer-shaped sub crystalline phase, the sub crystalline phase being different in elementary composition from that of the main crystalline phase however including a non-metallic element arrangement identical to that of the main crystalline phase, each of the main crystalline phase and the sub crystalline phase including at least one metallic element, at least one of the metallic element included in the sub crystalline phase being identical to a metallic element included in the main crystalline phase, the metallic element identical to that included in the sub crystalline phase being formed as a solid solution in the main crystalline phase.

Consequently, according to the configuration, the metallic element is formed as a solid solution in the main crystalline phase generated from the main crystalline phase raw material, and the same metallic element is formed as a solid solution also in the sub crystalline phase generated from the main crystalline phase and the compound or simple substance. Furthermore, the main crystalline phase and the sub crystalline phase both have identical non-metallic element arrangements. Hence, the main crystalline phase and the sub crystalline phase can be present with good affinity, thereby attaining an effect of allowing production of a multiple inorganic compound in which a layer-shaped sub crystalline phase is included in the main crystalline phase.

For a fuller understanding of the nature and advantages of the invention, reference should be made to the ensuing detailed description taken in conjunction with the accompanying drawings.

### BRIEF DESCRIPTION OF DRAWINGS

FIG. 1(a) illustrates an embodiment of the present invention, and is a perspective view illustrating a configuration of a multiple inorganic compound.

FIG. 1(b) illustrates an embodiment of the present invention, and is a perspective view illustrating a configuration of a multiple oxide.

FIG. 2 illustrates an embodiment of the present invention, and is a view illustrating a HAADF-STEM image of a cathode active material obtained in Example 1.

FIG. 3 illustrates an embodiment of the present invention, and is a view illustrating an EDX-element map of the cathode active material obtained in Example 1.

FIG. 4 illustrates an embodiment of the present invention, and is a view illustrating a HAADF-STEM image of a cathode active material obtained in Example 2.

FIG. 5 illustrates an embodiment of the present invention, and is a view of an EDX-element map of the cathode active material obtained in Example 2.

FIG. 6 is a view illustrating a HAADF-STEM image of a cathode active material obtained in Comparative Example 1.

FIG. 7 is a view illustrating an EDX-element map of the cathode active material obtained in Comparative Example 1.

### DESCRIPTION OF EMBODIMENTS

### Multiple Inorganic Compound

A multiple inorganic compound according to the present invention is a multiple inorganic compound including: a main crystalline phase including an inorganic compound, the main crystalline phase including a layer-shaped sub crystalline phase, the sub crystalline phase being different in elementary composition from that of the main crystalline phase however including a non-metallic element arrangement identical to that of the main crystalline phase, each of the main crystalline phase and the sub crystalline phase including at least one metallic element, at least one of the metallic element included in the sub crystalline phase being identical to a metallic element included in the main crystalline phase, the metallic element identical to that included in the sub crystalline phase being formed as a solid solution in the main crystalline phase. In the present specification, “formed as a solid solution” denotes a state in which at least one part is formed as a solid solution; a proportion in which the solid solution is formed is not limited.

The “non-metallic element” of the non-metallic element arrangement denotes an element other than a metallic element. Specific examples thereof encompass: boron, carbon, nitrogen, oxygen, fluorine, silicon, phosphorus, sulfur, chlorine, bromine, and iodine.

The “including a non-metallic element arrangement identical to that of the main crystalline phase” denotes that a non-metallic element included in both the main crystalline phase and sub crystalline phase has an identical non-metallic element arrangement in both the main crystalline phase and sub crystalline phase. These identical non-metallic element arrangements, in detail, may be distorted in a common or different manner in same or different axis directions. Moreover, an element having the identical non-metallic element arrangement may include a same or different partial defect, or this defect in the element may be arranged in accordance with a same or different rule. The main crystalline phase and sub crystalline phase may have a crystal system of any one of a cubic crystal, tetragonal crystal, orthorhombic crystal, monoclinic crystal, trigonal crystal, hexagonal crystal, or triclinic crystal; the crystal systems of the main crystalline phase and the sub crystalline phase may differ from or be identical to each other. As such, the non-metallic element arrangement of the sub crystalline phase is identical to the non-metallic element arrangement of an inorganic compound included in the main crystalline phase. As a result, it is possible to bond the sub crystalline phase and the main crystalline phase with good affinity, by use of the identical non-metallic element arrangement. This stabilizes the presence of the sub crystalline phase on a grain boundary and interface of the main crystalline phase. Furthermore, if the main crystalline phase and sub crystalline phase both have a spinel structure, it is possible to have the sub crystalline phase be present on the grain boundary and interface of the main crystalline phase with a further high affinity.

Main Crystalline Phase and Sub Crystalline Phase of Multiple Inorganic Compound

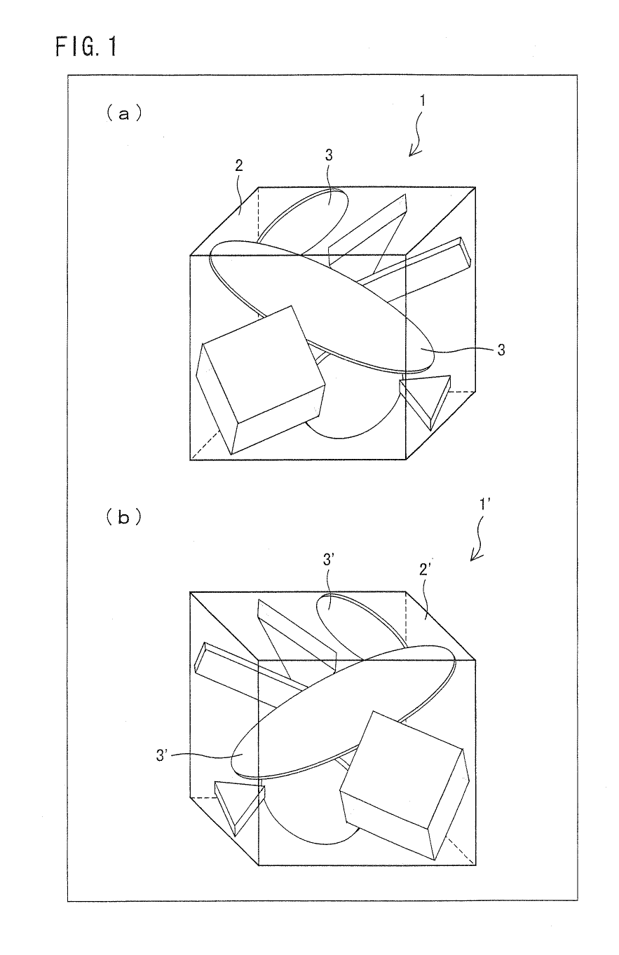

A multiple inorganic compound 1 according to the present invention has a main crystalline phase 2 as its main phase. In the multiple inorganic compound 1 illustrated in FIG. 1(a), a main crystalline phase 2 including a sub crystalline phase 3 is a phase that serves as a basis of the multiple inorganic compound 1. The main crystalline phase 2 includes an inorganic compound.

The inorganic compound included in the main crystalline phase is selected in accordance with an elementary composition of the sub crystalline phase. Hence, it is not possible to determine just the elementary composition of the main crystalline phase as having no alternative. Specific examples of the inorganic compound included in the main crystalline phase are described later together with the description of the inorganic compound that is included in the sub crystalline phase.

The sub crystalline phase 3 according to the present invention has an elementary composition different from that of the main crystalline phase, however has an identical non-metallic element arrangement as that of the main crystalline phase. Moreover, a same metallic element as at least one type of metallic element included in the sub crystalline phase 3 is formed as a solid solution in the main crystalline phase 2.

Examples of the elementary composition of the inorganic compound that is included in the main crystalline phase and sub crystalline phase are: in a case where the inorganic compound included in the main crystalline phase is BaAl₂S₄, the inorganic compound included in the sub crystalline phase can be a compound such as EuAl₂S₄, Eu₁₋ₓRₓAl₂S₄ (where R is a rare-earth element, and 0≦x≦0.05), EuAl₂₋ₓGaₓS₄ (where 0≦x≦2), EuAl₂₋ₓInₓS₄ (where 0≦x≦2), or like compounds; in a case where the inorganic compound included in the main crystalline phase is BaGa₄S₇, compounds such as BaAl₂S₄ can be used as the inorganic compound included in the sub crystalline phase; and in a case where the inorganic compound included in the main crystalline phase is Mn₁₋ₓZnₓS (where 0≦x≦0.01), compounds such as Zn₁₋ₓMnₓS (where 0≦x≦0.05) can be used as the inorganic compound of the sub crystalline phase. Moreover, in a case where the inorganic compound included in the main crystalline phase is K₂NiF₄, the inorganic compound included in the sub crystalline layer can be KMnF₃, KFeF₃, NaMgF₃ or like compound.

The sub crystalline phase 3 is included in the main crystalline phase 2. The sub crystalline phase 3 is not particularly limited in its shape as long as the sub crystalline phase 3 is of a layer shape. As illustrated in FIG. 1(a), the sub crystalline phase 3 can be disk-shaped, or be polygonal-shaped such as a triangular or a quadrilateral plate.

A layer thickness of the sub crystalline phase 3 is modified as appropriate, depending on a use of the multiple inorganic compound 1 and types of the main crystalline phase 2 and sub crystalline phase 3. Hence, it is difficult to specify the layer thickness as having no alternative. One example of the layer thickness of the sub crystalline phase 3 is a thickness in a range not less than 1 nm but not more than 100 nm.

With the sub crystalline phase 3 having the thickness in this range, it is possible to provide a multiple inorganic compound in which a sub crystalline phase is formed of nano order in the main crystalline phase. Moreover, it is possible to easily achieve the multiple inorganic compound of this thickness by the production method described later.

Multiple Oxide

A multiple oxide according to the present invention is a multiple oxide wherein the inorganic compound is an inorganic oxide, which multiple oxide includes a main crystalline phase including the inorganic oxide, wherein the main crystalline phase includes a layer-shaped sub crystalline phase, the sub crystalline phase being different in elementary composition from that of the main crystalline phase however including an oxygen arrangement identical to that of the main crystalline phase, each of the main crystalline phase and the sub crystalline phase including at least one metallic element, at least one of the metallic element included in the sub crystalline phase being identical to a metallic element included in the main crystalline phase, the metallic element identical to that included in the sub crystalline phase being formed as a solid solution in the main crystalline phase. Note that the multiple oxide is a type of the multiple inorganic acid compound.

The expression “including an oxygen arrangement identical to that of the main crystalline phase” denotes that the main crystalline phase and sub crystalline phase both include an oxygen element having identical oxygen arrangements. This identical oxygen arrangement, more specifically, may be commonly or differently distorted in a same or different axis direction. Further, the identical oxygen arrangements can have a same or different partial defect, or an oxygen defect may be arranged based on a same or different rule. A crystal system of the main crystalline phase and sub crystalline phase may be, one of a cubic crystal, tetragonal crystal, orthorhombic crystal, monoclinic crystal, trigonal crystal, hexagonal crystal, or triclinic crystal; the crystal systems of the main crystalline phase and sub crystalline phase may be same as or different from each other.

An example of a cubic crystal oxide is MgAl₂O₄, an example of a tetragonal crystal oxide is ZnMn₂O₄, and an example of an orthorhombic crystal oxide is CaMn₂O₄. The composition of these sub crystalline phases do not need to be stoichiometric; Mg or Zn can be partially substituted by another element such as Li or like element, or may contain a defect.

As such, the oxygen arrangement of the sub crystalline phase is identical to the oxygen arrangement of the inorganic oxide that is included in the main crystalline phase. Hence, it is possible to cause the sub crystalline phase to bond with the main crystalline phase with good affinity, by use of the identical oxygen arrangement. As a result, the sub crystalline phase is stably present on the grain boundary and interface of the main crystalline phase. Further, in a case where the main crystalline phase and sub crystalline phase both have a spinel structure, it is possible to have the sub crystalline phase be present on the grain boundary and interface of the main crystalline phase with a further high affinity.

One embodiment of the present invention is described below, with reference to FIG. 1(b). FIG. 1(b) is a perspective view illustrating a part of a multiple oxide 1′ according to the present embodiment. As shown in FIG. 1(b), the multiple oxide 1′ includes a main crystalline phase 2′ and a sub crystalline phase 3′, and the sub crystalline phase 3′ is formed as having a layer-shape inside the main crystalline phase 2′. First described is the main crystalline phase 2′.

Main Crystalline Phase and Sub Crystalline Phase of Multiple Oxide

The multiple oxide 1′ according to the present invention includes the main crystalline phase 2′ as its main phase. In the multiple oxide 1′ illustrated in FIG. 1(b), the main crystalline phase 2′ is a phase including the sub crystalline phase 3′, which main crystalline phase 2′ serves as a basis of the multiple oxide 1′. The main crystalline phase 2′ includes an inorganic oxide.

The inorganic oxide that makes up the main crystalline phase is selected in accordance with an elementary composition of the sub crystalline phase. Therefore, it is not possible to determine just the elementary composition of the main crystalline phase so as to have no alternative. Specific examples of the inorganic oxide that make up the main crystalline phase is described later together with the inorganic oxides that make up the sub crystalline phase.

The sub crystalline phase 3′ according to the present invention includes an elementary composition different from that of the main crystalline phase, however includes an oxygen arrangement identical to that of the main crystalline phase. Moreover, a metallic element that is the same as at least one type of metallic element included in the sub crystalline phase 3′ is formed as a solid solution in the main crystalline phase 2′.

Examples of the elementary composition of the inorganic oxide that is included in the main crystalline phase and those of the inorganic oxide that is included in the sub crystalline phase are: in a case where the inorganic oxide included in the main crystalline phase is LiMn₂O₄, the inorganic oxide included in the sub crystalline phase is: a solid solution such as MgAl₂O₄, MgFe₂O₄, MgAl₂₋ₓFeₓO₄ (where 0≦x≦2), spinel-type compounds that includes Mn, such as MgMn₂O₄, MnAl₂O₄, ZnMn₂O₄, CaMn₂O₄, and SnMn₂O₄, Zn—Sn, Mg—Al compounds such as ZnAl₂O₄, Zn_{0.33}Al_{2.45}O₄, SnMg₂O₄, Zn₂SnO₄, and MgAl₂O₄, and spinel-type compounds such as TiZn₂O₄, TiMn₂O₄, ZnFe₂O₄, MnFe₂O₄, ZnCr₂O₄. ZnV₂O₄, and SnCO₂O₄. The inorganic oxide included in the sub crystalline phase includes at least one type of metallic element of the inorganic oxide included in the main crystalline phase.

Moreover, in a case where the multiple oxide according to the present invention is used as a thermoelectric material, an example of the main crystalline phase according to the thermoelectric material is NaₓCoO₂ (where 0.3≦x≦1), and examples of the sub crystalline phase are Delafossite type compounds such as CuCoO₂, CuFeO₂, AgAlO₂, AgGaO₂, and AgInO₂. Moreover, in a case where the multiple oxide according to the present invention is used as a magnetic material, an example of the main crystalline phase according to the magnetic material is AFe₂O₄ (where A=Mn, Co, Ni, Cu, Zn), and examples of the sub crystalline phase are ZnMn₂O₄, ZnNi₂O₄, ZnCu₂O₄, and their solid solutions.

Moreover, the metallic element included in the sub crystalline phase is not particularly limited as long as the metallic element is formed as a solid solution in the main crystalline phase. For example, in a case where the main crystalline phase is LiMn₂O₄ and the sub crystalline phase is ZnMn₂O₄, Mn is an example of the metallic element. Moreover, in a case where the main crystalline phase is NaₓCoO₂ (where 0.3≦x≦1) and the sub crystalline phase is CuCoO₂, Co is an example of the metallic element. Furthermore, in a case where the main crystalline phase is MnFe₂O₄ and the sub crystalline phase is ZnMn₂O₄, Mn is an example of the metallic element. In any case, the inorganic oxide that is included in the main crystalline phase and the inorganic oxide that is included in the sub crystalline phase have a same metallic element formed as a solid solution.

The sub crystalline phase 3′ is included in the main crystalline phase 2′. The shape of the sub crystalline phase 3′ is not particularly limited as long as it is of a layer shape. As illustrated in FIG. 1(b), the sub crystalline phase 3′ may be disk-shaped, and also may be a polygonal shape such as a triangular or tetragonal plate shape.

The layer thickness of the sub crystalline phase 3′ is appropriately modified depending on a use of the multiple oxide 1′ and types of the main crystalline phase 2′ and sub crystalline phase 3′. Hence, it is difficult to specify the layer thickness as having no alternative. One example of the layer thickness of the sub crystalline phase 3′ is not less than 1 nm but not more than 100 nm.

With the sub crystalline phase 3′ having the thickness in this range, it is possible to provide a multiple oxide in which a sub crystalline phase is formed of nano order in the main crystalline phase. Moreover, it is possible to easily achieve this thickness by the production method of the multiple oxide described later.

In a case where the multiple oxide 1′ that includes manganese is used as the cathode active material of the nonaqueous secondary battery, it is possible to secure a thickness of the sub crystalline phase 3′ that can reduce the amount of Mn solving out of from the cathode active material while charging and discharging the secondary battery. At a time when Mn solves out from the main crystalline phase 2′, the sub crystalline phase 3′ serves as a barrier, thereby preventing the Mn from dissolving out. The sub crystalline phase 3′ is layer-shaped; even if the sub crystalline phase 3′ in the multiple oxide 1′ is of a small mixed amount, it is possible to prevent the solving out of Mn by covering the lithium-containing oxide. Furthermore, no obstruction of Li ion movement from the cathode active material occurs, which obstruction is caused by the thickness of the sub crystalline phase 3′ being too thick.

The sub crystalline phase 3′ can be confirmed as being formed as a layer shape, by observing the multiple oxide 1′ with a known electron microscope. HAADF-STEM or the like may be used as the electron microscope.

In the multiple oxide according to the present invention, the sub crystalline phase is included inside the main crystalline phase as having a layer-shape, and further by having the metallic element of the sub crystalline phase be formed as a solid solution in the main crystalline phase, the sub crystalline phase is present in the main crystalline phase in an extremely stable state.

The multiple oxide according to the present invention is not particularly limited in its application fields, and may be used in various fields. Typical examples for using the multiple oxide system include: a cathode active material for use in a nonaqueous electrolyte secondary battery, a thermoelectric conversion material, and a magnetic material. In the present specification, a “cathode active material” refers to the cathode active material for use in a nonaqueous electrolyte secondary battery, a “cathode” refers to a cathode of the nonaqueous electrolyte secondary battery, a “secondary battery” refers to the nonaqueous electrolyte secondary battery, and a “thermoelectric material” refers to a thermoelectric conversion material.

Cathode Active Material

The cathode active material according to the present invention includes the multiple inorganic compound. Among the multiple inorganic compound, it is preferable that the multiple oxide is included in the cathode active material. In the cathode active material according to the present invention, a lithium-containing transition metal oxide (hereinafter referred to as “lithium-containing oxide” as appropriate) that includes manganese may serve as the main crystalline phase. In general, the lithium-containing transition metal often has a spinel structure, however even if the lithium-containing transition metal does not have the spinel structure, this still can be used as the lithium-containing oxide of the present invention.

Namely, the lithium-containing oxide has a composition including at least lithium, manganese, and oxygen. Moreover, a transition metal other than manganese may be included. The transition metal other than manganese is not particularly limited as long as the transition metal does not obstruct the function of the cathode active material. Specific examples of the transition metal encompass: Ti, V, Cr, Ni, and Cu. However, the lithium-containing oxide preferably includes just manganese as the transition metal, in view that the lithium-containing transition metal oxide can be synthesized easily.

A composition ratio of the lithium-containing oxide, in a case of the spinel structure, can be represented as Li:M:O=1:2:4, where the transition metal that includes manganese is M. The transition metal M may include the foregoing Ti, V, Cr, Ni, Cu and/or the like.

However, in the case of the spinel structure, the composition ratio often varies from the Li:M:O=1:2:4 in practice, and the same applies with the cathode active material according to the present invention. A composition ratio of a non-stoichiometric compound having a different oxygen content from the foregoing composition ratio is, for example, Li:M:O=1:2:3.5-4.5 or 4:5:12.

In a case where the cathode active material of the present invention includes just a small mixed amount of the lithium-containing oxide, there is a possibility that a discharge capacity of the secondary battery that makes the cathode active material a cathode material is reduced in capacity. Hence, in a case where the cathode active material is represented by the following general formula A:

Li₁₋ₓM1₂₋₂ₓM2ₓM3₂ₓO_{4-y} (A)

where M1 is at least one type of element of manganese or of manganese and a transition metal element, each of M2 and M3 are at least one type of element of a representative metal element or of a transition metal element; and y is a value satisfying electrical neutrality with x,
x in the general formula A is preferably 0.01≦x≦0.20. Moreover, it is preferable that y satisfies the inequation of 0≦y≦2.0, further preferable satisfying 0≦y≦1.0, and particularly preferable satisfying 0≦y≦0.5. Moreover, y is a value that satisfies electrical neutrality with x, and y can at times be 0, Specific examples of M2 and M3 are, for example, M2 being Sn and M3 being Zn, or M2 being Mg and M3 being Al.

The general formula A is derived as follows. Note that x is in a range of 0.01≦x≦0.20.

First considered is a case where (1-x)LiMn₂O₄-xZn₂SnO₄ according to Example later described is produced. Li₂CO₃, MnO₂, and an oxide Zn₂SnO₄ are used as a starting raw material. Li₂CO₃ reacts with MnO₂ and becomes LiMn₂O₄. Carbonate components disappear, thereby making it possible to express its reactant as LiMn₂O₄. Hence, reorganization of the (1-x)LiMn₂O₄ and xZn₂SnO₄ into one formula results in attaining the following formula:

(1-x)LiMn₂O₄+xZn₂SnO₄→Li₁₋ₓMn₂₍₁₋ₓ₎Zn₂ₓSnₓO₄.

Moreover, as a different example, (1-x)LiMn₂O₄ and xMgAl₂O₄ can be reorganized as in the following formula:

(1-x)LiMn₂O₄+xMgAl₂O₄→Li₁₋ₓMn₂₍₁₋ₓ₎MgₓAl₂ₓO₄.

Therefore, by generalizing the oxide with A¹B¹₂O₄, an entire composition formula is expressed as:

(1-x)LiMn₂O₄+xA¹B¹₂O₄→Li₁₋ₓMn₂₍₁₋ₓ₎A¹ₓB¹₂ₓO₄.

Moreover, in a case where there are two types of oxides: A¹B¹₂O₄ and A²B²₂O₄, and a cathode active material is produced by mixing these by x₁ and x₂ with respect to an entire amount, respectively, the formula is represented by:

(1-x)LiMn₂O₄+x₁A¹B¹₂O₄+x₂A²B²₂O₄→Li₁₋ₓ_{₁}₋ₓ_{₂}Mn₂₍₁₋ₓ_{₁}₋ₓ_{₂₎}A¹ₓ_{₁}A²ₓ_{₂}B¹₂ₓ_{₁}B²₂ₓ_{₂}O₄ [Chem. 1]

By generalizing this formula, namely, to a state in which includes a large amount of elementary composition and is large in mixed amount, the formula becomes represented by:

$$( 1 - x ) {LiMn}_{2} {O}_{4} + {x}_{1} {A}^{1} {B}_{2}^{1} {O}_{4} + {x}_{2} {A}^{2} {B}_{2}^{2} {O}_{4} + … {x}_{n} {A}^{n} {B}_{2}^{n} {O}_{4} + … \to {Li}_{1 - {\sum }_{i} {x}_{i}} {Mn}_{2 ( 1 - {\sum }_{i} {x}_{i} )} {A}_{{x}_{1}}^{1} {A}_{{x}_{2}}^{2} … {A}_{{x}_{n}}^{n} {B}_{2 {x}_{1}}^{1} {B}_{2 {x}_{2}}^{2} … {B}_{2 {x}_{n}}^{n} {O}_{4} \qquad [ Chem . 2 ]$$

### Here,

$$x = {\sum }_{i} {x}_{i} , \\ M 2 = {A}_{\frac{{x}_{1}}{x}}^{1} {A}_{\frac{{x}_{2}}{x}}^{2} … {A}_{\frac{{x}_{n}}{x}}^{n} , and \\ M 3 = {B}_{\frac{{x}_{1}}{x}}^{1} {B}_{\frac{{x}_{2}}{x}}^{2} … {B}_{\frac{{x}_{n}}{x}}^{n} , \qquad [ Chem . 3 ]$$

and since Mn can be configured of at least one of Mn or Mn and a transition metallic element, Mn=M1. Further, the compound satisfies an electrically neutral condition, so the general formula A is, as a result, represented by:

Li₁₋ₓM1₂₋₂ₓM2ₓM3₂ₓO_{4-y}.

On the other hand, the sub crystalline phase preferably includes, as a contained element, a representative element and manganese. The foregoing structure, by including manganese and the representative element in the composition of the sub crystalline phase, allows stabilizing the sub crystalline phase that includes the oxygen arrangement identical to that of the lithium-containing oxide. Hence, it is possible to further reduce the solving out of Mn from the sub crystalline phase.

The representative element is not particularly limited, and examples thereof include magnesium, zinc, and like elements. Definitions of the representative element and transition metallic element are described in the following reference (Cotton, Wilkinson; Translation by Masayoshi Nakahara, “Mukikagaku (Inorganic Chemistry) <Vol. 1>”, Tokyo, Baifukan, 1991 (Original reference: F. A. Cotton, G. Wilkinson, Advanced Inorganic Chemistry—A Comprehensive Text, 4th edition, INTERSCIENCE, 1980)).

A transition metal is an element that has a d orbital incompletely filled with electrons or an element that causes generation of such a positive ion; a representative element denotes any other element. For example, an electron configuration of a zinc atom Zn is 1s²2s²2p⁶3s²3p⁶4s²3d¹⁰, and a positive ion of zinc is Zn²⁺, which is 1s²2s²2p⁶3s²3p⁶3d¹⁰. The atom and the positive ion are both 3d¹⁰, and do not have “an incompletely filled d orbital”; hence, Zn is a representative element.

Moreover, the sub crystalline phase preferably includes zinc and manganese. The foregoing structure, by including zinc and manganese in the composition of the sub crystalline phase, allows particularly stabilizing the sub crystalline phase that includes the oxygen arrangement identical to that of the lithium-containing oxide. Hence, it is possible to particularly preferably reduce the solving out of Mn from the sub crystalline phase.

Particularly, in a case where the sub crystalline phase contains zinc and manganese, a composition ratio Mn/Zn of zinc and manganese is preferably 2<Mn/Zn<4, and is further preferably 2<Mn/Zn<3.5. It is preferable to have the composition ratio of zinc and manganese in the foregoing range since the solving out of Mn is preferably reduced.

It is preferable that a lattice constant of the main crystalline phase, in a case where the main crystalline phase is a cubic crystal or is approximately a cubic crystal, is not less than 8.22 Å but not more than 8.25 Å. If the lattice constant of the main crystalline phase is within the foregoing range, the sub crystalline phase can be bonded to the main crystalline phase with good affinity, since the lattice constant matches with gaps between oxygen atoms and an arrangement of the oxygen atoms on an arbitrary side of the sub crystalline phase that has an oxygen arrangement identical to the main crystalline phase. Hence, it is possible to have the sub crystalline phase be stably present on the grain boundary and interface of the main crystalline phase.

With the cathode active material according to the present invention, the sub crystalline phase is provided inside the main crystalline phase so as to have a layer shape. Therefore, in a case where the cathode active material is used as a cathode material of the secondary battery, it is possible to physically block, with use of the sub crystalline phase, Mn from solving out into the ion conductor from the cathode active material during the charge and discharge process. That is to say, the sub crystalline phase serves as a barrier that prevents Mn from solving out; as a result, it is possible to reduce the solving out of Mn. This makes it possible to provide a cathode active material that can achieve a nonaqueous electrolyte secondary battery having remarkably improved cycle characteristics.

If the amount of the sub crystalline phase mixed in the cathode active material of the present invention is great, a relative amount of the lithium-containing oxide decreases when the cathode active material is used as a cathode material of a secondary battery. This may cause the discharge capacity of the cathode active material to decrease. On the other hand, if the amount of the sub crystalline phase mixed in the cathode active material is small, the effect of preventing Mn from solving out from the main crystalline phase decreases, thereby reducing the effect of improving the cycle characteristics of the secondary battery. Hence, this is not preferable.

In consideration of these matters and in consideration of a balance between the decrease in discharge capacity and attainment of the effect of improving cycle characteristics, a preferable mixed amount of the sub crystalline phase with respect to the cathode active material is an amount in which, in the general formula A, x is in the range of 0.01≦x≦0.10, further preferably in the range of 0.03≦x≦0.07.

Moreover, the inventors found as a result of diligent study that the sub crystalline phase of the main crystalline phase preferably has a crystallinity that is detectable by diffractometry (crystal diffractometry). Examples of the diffractometry include X-ray diffractometry, neutron diffractometry, and electron diffractometry. Such a sub crystalline phase has high crystallinity, and in a case where the cathode active material is used as the active material of the lithium ion secondary battery, it is possible to physically hold down expansion or shrinking that occurs upon insertion of lithium into or elimination of lithium from the main crystalline phase. Hence, it is possible to reduce the amount in which crystal particles that are included in the cathode active material are deformed, and as a result, makes it difficult to cause the crystal particles to crack or the like. Consequently, it is possible to provide a cathode active material capable of attaining a secondary battery that makes it difficult to have the discharge capacity decrease.

<Method of Producing Multiple Inorganic Compound>

The following description deals with how to produce the multiple inorganic compound according to the present invention. First, a method of the present invention of producing the multiple inorganic compound includes a baking step for baking (a) the main crystalline phase raw material and (b) a compound including at least one type of metallic element formable as a solid solution in the main crystalline phase, or a simple substance of the metallic element.

The main crystalline phase raw material may be an inorganic compound that is included in the main crystalline phase, or may be one which becomes the main crystalline phase by baking the raw material. More specifically, in a case where the inorganic compound that is included in the main crystalline phase is BaAl²S₄, raw materials of the main crystal can be a combination of BaS and Al₂S₃. Moreover, in a case where the inorganic compound that is included in the main crystalline phase is Mn₁₋ₓZnₓS (where 0≦x≦0.01), the raw material of the main crystal may be a combination of ZnS and MnS.

The inorganic compound includes at least one type of metallic element to be formed as a solid solution in the main crystalline phase. For example, in a case where the main crystalline phase raw materials that makes up the main crystalline phase is BaS and Al₂S₃, a metallic element to be formed as a solid solution in the main crystalline phase is Eu. Examples of compounds that include Eu encompass solid solutions such as EuAl₂S₄, EuAl₂₋ₓGaₓS₄ (where 0≦x≦2), and EuAl₂₋ₓInₓS₄ where 0≦x≦2).

Moreover, in a case where the main crystalline phase raw materials that makes up the main crystalline phase is ZnS and MnS, a metallic element to be formed as a solid solution in the main crystalline phase is Zn. An example of a compound that includes Zn is Zn₁₋ₓCdₓS (where 0≦x≦1).

Examples that use the main crystalline phase raw material and compounds are as described above. However, a simple substance such as Eu, Al, Ga, and S may be used instead of the compounds, or a compound and a simple substance can be used simultaneously.

Moreover, it is preferable to add (a) an element that is included in the main crystalline phase as raw material of the sub crystalline phase or (b) a compound including (i) an element included in the main crystalline phase and (ii) an element which is eliminated from the multiple inorganic compound at the time of baking the main crystalline phase, before baking the raw material and the compound or simple substance.

By adding the compound as described above, it is possible to form the metallic element in the main crystalline phase as a solid solution more easily, thereby making it possible to easily produce the multiple inorganic compound according to the present invention.

The “element which is eliminated” is not included in the main crystalline phase or the sub crystalline phase since its raw material is extricated upon baking the raw material. Namely, the “element which is eliminated” denotes an element that is not included in the multiple inorganic compound at the time of baking, and is eliminated from the multiple inorganic compound.

More specifically, in a case where a raw material of an inorganic compound BaAl₂S₄ that makes up the main crystalline phase is recognized as BaS and Al₂S₃, and a compound containing Zn is ZnMgS, the element that is eliminated is Mg.

In the baking step, the main crystalline phase raw material and the compound or simple substance is baked, to produce the multiple inorganic compound according to the present invention.

As a preparational stage prior to baking the main crystalline phase raw material and the compound or simple substance, the main crystalline phase raw material and the compound or the simple substance is added by a set added amount, and the main crystalline phase raw material and the compound or the simple substance are evenly mixed together (mixing step). A known mixing equipment such as a mortar or a planetary ball mill is usable in the mixing process.

Entire amounts of the main crystalline phase raw material and the compound or simple substance may be mixed at once, or small amounts of the compound or simple substance can be gradually added to the entire amount of the main crystalline phase. The latter case causes a gradual increase in concentration of the spinel-type compound, for example, which allows mixing the mixture to be more evenly mixed. For this reason, the latter case is more preferable.

A baking temperature of baking the mixture of the main crystalline phase raw material and the compound or simple substance is set in accordance with the baking object, however can be typically baked in a temperature range of not less than 400° C. but not more than 1300° C. Moreover, typically, the baking time is preferably not more than 48 hours.

As described above, by having the compound or simple substance be baked with the main crystalline phase raw material, a part of the metallic element is formed as a solid solution in the baked main crystalline phase, and the main crystalline phase raw material and the compound or simple substance is baked to form a sub crystalline phase that includes the metallic element. At this point, if the inorganic compound includes an element that cannot be formed as a solid solution in the main crystalline phase, such an element will not be included in the multiple inorganic compound; as a result, the element remains and is eliminated from the multiple inorganic compound.

<Method of Producing Multiple Oxide>

The following description explains how to produce the multiple oxide, according to the present invention. First, a method of the present invention of producing the multiple oxide includes: baking (a) a main crystalline phase raw material and (b) a compound including at least one metallic element that is dissolvable in the main crystalline phase or a simple substance of the at least one metallic element.

Moreover, in a case where the inorganic oxide included in the main crystalline phase is LiMn₂O₄, the main crystalline phase raw material is Li₂CO₃ and MnO₂. Moreover, as other main crystalline phase raw material, in a case where the main crystalline phase is NaₓCoO₂ (where 0.3≦x≦1), the main crystalline phase raw material is Na₂CO₃ and Co₃O₄. Moreover, in a case where the main crystalline phase is MnFe₂O₄, the main crystalline phase raw material is FeCO₃ and MnO₂.

Furthermore, for example, in a case where the main crystalline phase raw material that makes up the main crystalline phase is Li₂CO₃ and MnO₂, the metallic element to be dissolved in the main crystalline phase is Zn. Examples of compounds that include Zn are Zn₂SnO₄ and ZnAl₂O₄.

Moreover, in a case where the main crystalline phase raw material that makes up the main crystalline phase is Na₂CO₃ and CO₃O₄, the metallic element to be dissolved into the main crystalline phase is Cu. Examples of compounds that include Cu are CuGaO₂, CuYO₂, and CuLaO₂.

Furthermore, in a case where the main crystalline phase raw material that makes up the main crystalline phase is Fe₂CO₃ and MnO₂, the metallic element to be dissolved in the main crystalline phase is Zn. Examples of compounds that include Zn encompass Zn₂SnO₄ and ZnAl₂O₄.

The foregoing description explains examples that use the main crystalline phase raw material and the compound. Alternatively, a simple substance such as Zn, Al, Sn, Cu, Ga, Mn, La, Y, or O₂ may be used instead of the compound, or a compound and a simple substance may be used simultaneously.

Moreover, it is preferable that (a) an element included in the main crystalline phase as raw material of the sub crystalline phase or (b) a compound including an element included in the main crystalline phase and an element which is eliminated from the multiple oxide upon baking the main crystalline phase be added before baking the main crystalline phase.

By adding the compound as the aforementioned, the metallic element is more easily formed as a solid solution in the main crystalline phase, thereby making it possible to produce the multiple oxide according to the present invention easily.

The “element which is eliminated” is not included in the main crystalline phase or the sub crystalline phase since its raw material is extricated upon baking the raw material. Namely, the “element which is eliminated” denotes an element that is not included in the multiple oxide at the time of baking, and is eliminated from the multiple oxide.

More specifically, in a case where a raw material of an inorganic oxide LiMn₂O₄ included in the main crystalline phase is Li₂CO₃ and MnO₂, and an oxide containing Zn is Zn₂SnO₄, the element to be eliminated is Sn.

The baking step bakes the main crystalline phase raw material and the compound or simple substance, to produce the multiple oxide according to the present invention. As a preparational stage prior to baking the main crystalline phase raw material and the compound or simple substance, the main crystalline phase raw material and the compound or the simple substance is added by a set added amount, and the main crystalline phase raw material and the compound or the simple substance are evenly mixed together (mixing step). A known mixing equipment such as a mortar or a planetary ball mill is usable in the mixing process.

Entire amounts of the main crystalline phase raw material and the compound or simple substance may be mixed at once, or small amounts of the compound or simple substance can be gradually added to the entire amount of the main crystalline phase. The latter case causes a gradual example, which allows mixing the mixture to be more evenly mixed. For this reason, the latter case is more preferable.

A baking temperature of baking the mixture of the main crystalline phase raw material and the compound or simple substance is set in accordance with the baking object, however can be typically baked in a temperature range of not less than 400° C. but not more than 1000° C. Moreover, typically, the baking time is preferably not more than 48 hours.

As described above, by having the compound or simple substance be baked with the main crystalline phase raw material, a part of the metallic element is dissolved into the baked main crystalline phase, and the main crystalline phase raw material and the compound or simple substance is baked to form a sub crystalline phase that includes the metallic element. At this point, if the inorganic compound includes an element that cannot be dissolved into the main crystalline phase, such an element will not be included in the multiple inorganic compound; as a result, the element remains and is eliminated from the multiple inorganic compound.

More specifically, in the case where the raw material of the inorganic oxide LiMn₂O₄ included in the main crystalline phase is Li₂CO₃ and MnO₂ and the oxide containing Zn is Zn₂SnO₄, the Zn inside Zn₂SnO₄ is formed as a solid solution in LiMn₂O₄ whereas Sn is an element that cannot be formed as a solid solution in LiMn₂O₄. Upon baking Li₂CO₃, MnO₂, and Zn₂SnO₄, LiMn₂O₄ is formed as the main crystalline phase, and a part of Zn is formed as a solid solution in LiMn₂O₄.

On the other hand, Sn does not dissolve into the main crystalline phase. Sn is not included as the multiple oxide; ZnxMnyO₄ is formed as the sub crystalline phase. The X and Y satisfy the inequations: 0.8≦X≦1.2 and 2≦X/Y≦4.

Baking within this baking time range allows an intermediate phase to be present on an interface of the main crystalline phase with the sub crystalline phase, in the obtained multiple oxide, which intermediate phase includes a part of elements of the main crystalline phase and a part of elements same as or different from the sub crystalline phase. With such an interface formed, the main crystalline phase can be strongly bonded with the sub crystalline phase. Hence, it is possible to obtain a cathode active material in which breakage and the like is further difficult to occur.

The interface is a borderline on which the main crystalline phase and the sub crystalline phase are in contact with each other. Furthermore, the intermediate phase is a region that is present on the interface of the main crystalline phase with the sub crystalline phase, in which the elements of the main crystalline phase and those of the sub crystalline phase are mixed together. The intermediate phase includes the elements that are included in the main crystalline phase and those included in the sub crystalline phase in a mixed manner, in different proportions per type of element. The intermediate phase is a phase different from the main crystalline phase or the sub crystalline phase, and is constituted of one or more types of compound that includes all or part of the elements included in the main crystalline phase and the sub crystalline phase. Moreover, the proportion of the elements that are included in the intermediate phase may vary depending on a position in the intermediate phase. For instance, the proportion of the mixed elements may differ in the intermediate phase between a position close to the main crystalline phase and a position close to the sub crystalline phase.

Moreover, whether or not the main crystalline phase and the sub crystalline phase are formed as a solid solution can be confirmed by X-ray diffractometry. More specifically, if both a peak of the main crystalline phase and a peak of the sub crystalline phase are detected, then the main crystalline phase and the sub crystalline phase are not formed as a solid solution. In comparison, if the sub crystalline phase is mixed into the main crystalline phase as a solid solution, the peak of the sub crystalline phase cannot be detected, and further the peak of the main crystalline phase in the X-ray diffractometry profile largely shifts as compared to the peak in the case where the sub crystalline phase is not mixed into the main crystalline phase as a solid solution.

Baking for a long period of time may cause the entire amount of the oxide containing Zn to disperse inside the main crystalline phase; this may cause formation of a complete solid solution. If a complete solid solution is formed, the sub crystalline phase will not be formed to have a layer shape. For this reason, baking for a long period of time is not preferable.

The baking may be carried out under air atmosphere, or may be carried out under an atmosphere having increased oxygen content. Moreover, the baking process may be repeated several times. In this case, the baking for a first time (pre-baking) and the baking for second and subsequent times may be carried out at a same temperature or at different temperatures. Furthermore, in the case where the baking is repeated a plurality of times, a sample may be crushed and again be shaped into a pellet shape by applying pressure, while the plurality of baking processes are carried out.

<Method of Producing Secondary Battery>

The foregoing description explains how to produce the multiple oxide according to the present invention. The following description deals with how to produce a secondary battery by use of the multiple oxide of the present invention particularly as the cathode active material. First described is how to produce a raw material compound of a sub crystalline phase, which raw material compound serves as a raw material of the cathode active material.

Method of Producing Raw Material Compound of Sub Crystalline Phase

How to produce a spinel-type compound that is a raw material compound of the sub crystalline phase in a case where its use is to produce the cathode active material is not particularly limited; a known solid phase method, hydrothermal method or the like may be used. Moreover, a sol-gel process or spray pyrolysis may also be used.

In producing the spinel-type compound by the solid phase method, raw material including an element to be included in the sub crystalline phase is used as the raw material of the spinel-type compound. Oxides and chlorides such as carbonates, nitrates, sulfates, and hydrochlorides, each of which include the element, can be used as the raw material.

More specifically, examples of the raw material encompass: manganese dioxide, manganese carbonate, manganese nitrate, lithium oxide, lithium carbonate, lithium nitrate, magnesium oxide, magnesium carbonate, magnesium nitrate, calcium oxide, calcium carbonate, calcium nitrate, aluminium oxide, aluminum nitrate, zinc oxide, zinc carbonate, zinc nitrate, iron oxide, iron carbonate, iron nitrate, tin oxide, tin carbonate, tin nitrate, titanium oxide, titanium carbonate, titanium nitrate, vanadium pentoxide, vanadium carbonate, vanadium nitrate, cobalt oxide, cobalt carbonate, and cobalt nitrate.

Moreover, the following may be used as the raw material: a hydrolysate Me_{X}(OH)_{X} of a metal alkoxide including an element Me contained in the sub crystalline phase, where Me is, for example, manganese, lithium, magnesium, aluminium, zinc, iron, tin, titanium, vanadium or the like, and X is a valence of the element Me; or a solution of a metal ion including the element Me. The solution of the metal ion is used as the raw material in a state in which the solution is mixed with a thickening agent or a chelating agent. The oxides may be used solely, or a plurality of the oxides may be used in combination.

The thickening agent and chelating agent are not particularly limited, and a known thickening agent can be used. For example, thickening agents such as ethylene glycol and carboxymethyl cellulose and chelating agents such as ethylenediaminetetraacetic acid and ethylene diamine can be used.

The spinel-type compound is obtained by mixing and baking the raw material so that an element content in the raw material is of a composition ratio of a target sub crystalline phase. A baking temperature is adjusted in accordance with a temperature of the raw material used, so it is difficult to set the temperature so as to have no alternative. However, the baking is typically carried out at a temperature of not less than 400° C. but not more than 1500° C. An atmosphere to carry out the baking may be inactive, or may include oxygen.

Moreover, synthesis of the spinel-type compound is also possible by a hydrothermal method, in which an acetate, chloride or the like is dissolved in an alkaline aqueous solution in a well-closed container, which acetate, chloride or the like are raw material including the element included in the spinel-type compound, and this mixture is heated. In a case where the spinel-type compound is synthesized by the hydrothermal method, an obtained spinel-type compound can be used in a subsequent process of producing the cathode active material, or can be used in the process of producing the cathode active material after the obtained spinel-type compound is treated by heat.

If the spinel-type compound obtained by the foregoing method has an average particle size larger than 100 μm, it is preferable that the average particle size is made smaller. The average particle size of the spinel-type compound may be made smaller by, for example, crushing the spinel-type compound with a mortar, a planetary ball mill or the like to reduce the particle size, or by classifying the particle size of the spinel-type compound with a mesh or the like and using the spinel-type compound having a small average particle size in the subsequent processes.

Production of Cathode Active Material

Subsequently, the cathode active material is produced by carrying out, to the obtained spinel-type compound: (1) synthesis of the spinel-type compound at a single phase state, mixing to the synthesized spinel-type compound a lithium source material and manganese source material (raw material of main crystalline phase) which are raw material of the lithium-containing oxide, and thereafter baking this mixture; or (2) synthesis of the spinel-type compound at a single phase state, further mixing to the synthesized spinel-type compound a lithium-containing oxide (raw material of main crystalline phase) that is synthesized separately to the spinel-type compound, and thereafter baking this mixture. As described above, the cathode active material according to the present embodiment is produced by use of a spinel-type compound obtained in advance.

In a case where the method (1) is used, first, the spinel-type compound is mixed with the lithium source material and manganese source material in accordance with a desired lithium-containing oxide.

Examples of the lithium source material encompass lithium carbonate, lithium hydroxide, lithium nitrate and the like. Moreover, examples of the manganese source material encompass manganese dioxide, manganese nitrate, manganese acetate and the like. It is preferable to use electrolytic manganese dioxide as the manganese source material.

Moreover, transition metal raw material that includes a transition metal other than manganese may be used together with the manganese source material. Examples of the transition metal encompass Ti, V, Cr, Ni, Cu, Fe, Co, and like transition metals, and oxides and chlorides (e.g., carbonates, hydrochlorides and the like) of these transition metals can be used as the transition metal raw material.

After the lithium source material and manganese source material (including transition metal raw material) to be mixed are selected, the lithium source material and the manganese source material (including the transition metal raw material) are mixed into the spinel-type compound so that a ratio of Li in the lithium source material and a ratio of the manganese source material (including the transition metal raw material) in the lithium source material become ratios of a preferred lithium-containing oxide. For example, in a case where the preferred lithium-containing oxide is LiM₂O₄ (M is manganese and a transition metal), content of the lithium source material and manganese source material (including transition metal raw material) is set so that the ratio of Li to M is 1:2.

After the spinel-type compound, lithium source material, and manganese source material are mixed so as to have the set content, these materials are evenly mixed together (mixing process). A known mixing equipment such as a mortar or a planetary ball mill is usable in the mixing process.

Entire amounts of the spinel-type compound, the lithium source material, and the manganese source material may be mixed at once, or small amounts of the lithium source material and manganese source material can be gradually added to the entire amount of the spinel-type compound. The latter case causes a gradual decrease in concentration of the spinel-type compound, which allows mixing the mixture to be more evenly mixed. For this reason, the latter case is more preferable.

The mixed raw material is further baked, to produce the cathode active material (baking process). In order to easily bake the mixed raw material, the mixed raw material is preferably shaped into a pellet shape by applying pressure, and thereafter is baked in the pellet shape. The baking temperature is set depending on the types of mixed raw material, however is typically baked in a temperature range of not less than 400° C. but not more than 1000° C. Moreover, a typical baking time is preferably not more than 12 hours.

Baking within this baking time range allows an intermediate phase including a part of elements of the main crystalline phase and a part of elements same as or different from the sub crystalline phase to be present on an interface of the main crystalline phase with the sub crystalline phase, in the obtained cathode active material. With such an interface formed, the main crystalline phase can be strongly bonded with the sub crystalline phase. Hence, it is possible to obtain a cathode active material in which breakage and the like is further difficult to occur.

The interface is a borderline on which the main crystalline phase and the sub crystalline phase are in contact with each other. Furthermore, the intermediate phase is a region that is present on the interface of the main crystalline phase with the sub crystalline phase, in which the elements of the main crystalline phase and those of the sub crystalline phase are mixed together. The intermediate phase includes the elements that are included in the main crystalline phase and those included in the sub crystalline phase in a mixed manner, in different proportions per type of element. The intermediate phase is a phase different from the main crystalline phase or the sub crystalline phase, and is constituted of one or more types of compound that includes all or part of the elements included in the main crystalline phase and the sub crystalline phase.

Moreover, the proportion of the elements that are included in the intermediate phase may vary depending on position. For instance, the proportion of the mixed elements may differ in the intermediate phase between a position close to the main crystalline phase and a position close to the sub crystalline phase.

It is not preferable to carry out baking for a long period of time, since such baking causes an entire amount of the spinel-type compound to disperse into the main crystalline phase, thereby possibly forming a complete solid solution. In a case where a complete solid solution is formed, the spinel-type compound cannot be formed to have a layer-shape.

The baking may be carried out under air atmosphere, or may be carried out under an atmosphere having increased oxygen content. Moreover, the baking process may be repeated several times. In this case, the baking for a first time (pre-baking) and the baking for second and subsequent times may be carried out at a same temperature or at different temperatures. Furthermore, in the case where the baking is repeated a plurality of times, a sample may be crushed and again be shaped into a pellet shape by applying pressure, while the plurality of baking processes are carried out.

An extremely preferable method for producing the cathode active material is to (i) synthesize Zn₂SnO₄ at a single phase state, which Zn₂SnO₄ is a spinel compound including a part of raw material of the sub crystalline phase, (ii) mix the raw material with lithium source material and Mn and thereafter (iii) bake this mixture. This is because the cathode active material obtained as a result achieves largely improved cycle characteristics of the secondary battery.

Production of Cathode

The cathode active material obtained as described above is processed into a cathode by the following known procedure. The cathode is formed by use of a mixture in which the cathode active material, a conductive additive material, and a binding agent are mixed together.

The conductive additive material is not particularly limited, and a known conductive additive material can be used. Examples thereof include: carbons such as carbon black, acetylene black, and KETJENBLACK; graphite (natural graphite, synthetic graphite) powder; metal powder; metal fiber; and the like.

The binding agent is not particularly limited, and a known binding agent can be used. Examples thereof encompass: fluorinated polymers such as polytetrafluoroethylene and polyvinylidene fluoride; polyolefin polymers such as polyethylene, polypropylene, and ethylene-propylene-diene terpolymer; and styrene-butadiene rubber.

An appropriate mixing ratio of the conductive additive material and the binding agent differs depending on the type of the mixed conductive additive material and binding agent, and is difficult to set so as to have no alternative. However, typically, the mixing ratio of the conductive additive material is not less than 1 part by weight to not more than 50 parts by weight and the mixing ratio of the binding agent is not less than 1 part by weight to not more than 30 parts by weight, each with respect to 100 parts by weight of the cathode active material.

If the mixing ratio of the conductive additive material is less than 1 part by weight, resistance, polarization or the like of the cathode increases and the discharge capacity decreases. Hence, a practical secondary battery may not be produced with the obtained cathode. On the other hand, if the mixing ratio of the conductive additive material exceeds 50 parts by weight, the mixed ratio of the cathode active material included in the cathode decreases. This causes the discharge capacity as the cathode to decrease.

Moreover, if the mixing ratio of the binding agent is less than 1 part by weight, a binding effect may not be expressed. On the other hand, if the mixing ratio of the binding agent exceeds 30 parts by weight, the amount of active material included in an electrode decreases as with the case of the conductive additive material, and furthermore, as described above, the resistance, polarization or the like of the cathode increases and the discharge capacity decreases. Hence, this is not practical.

Other than the conductive additive material and the binding agent, the mixture may also use a filler, a dispersing agent, an ion conductor, a pressure enhancing agent, and other various additives. The filler can be used without any particular limitations as long as the filler is fiber material that does not chemically change in properties in the obtained secondary battery. Usually, olefin polymers such as polypropylene and polyethylene, and fibers such as glass are used as the filler. The filler is not particularly limited in its added amount, however is preferably not less than 0 parts by weight to not more than 30 parts by weight with respect to the mixture.

The method of forming the mixture in which the cathode active material, the conductive additive material, the binding agent, various additives and the like are mixed together, is not particularly limited. Examples of such a method include: a method of forming a pellet-shaped cathode by compressing the mixture; and a method of forming a sheet-shaped cathode by preparing a paste by adding an appropriate solvent to the mixture, applying this paste on a collector, and thereafter drying and further compressing this collector on which the paste is applied.

The collector carries out transfer of electrons from or to the cathode active material in the cathode. Accordingly, the collector is provided to the cathode active material. Sole metal, an alloy, a carbon or the like is used as the collector. For instance, a sole metal such as titanium or aluminium, an alloy such as stainless steel, or carbon is used. Moreover, a collector having a surface made of copper, aluminium, or stainless steel on which a carbon, titanium, or silver layer is formed, or, a collector whose surface made of copper, aluminium, or stainless steel is oxidized, may also be used.

Examples of a shape of the collector, other than a foil-shape, encompass a film, a sheet, a net, and a punched-out shape. The collector may be configured as a lath structure, porous structure, foam, formed fibers, or like structure. The collector used in the embodiment has a thickness of not less than 1 μm but not more than 1 mm; however, the thickness thereof is not particularly limited.

Production of Anode

An anode of the secondary battery of the present invention includes an anode active material, which can have (a) a substance including lithium or (b) lithium be inserted into or eliminated from the anode active material. In other words, the anode includes an anode active material in which (a) the substance including lithium or (b) lithium can be occluded or discharged.

A known anode active material is used as the anode active material. Examples of the anode active material encompass: lithium alloys such as metal lithium, lithium/aluminum alloy, lithium/tin alloy, lithium/lead alloy, and wood's alloy; a substance that can electrochemically dope and dedope lithium ion such as conductive polymers (polyacetylene, polythiophene, and polyparaphenylene), pyrolytic carbon, pyrolytic carbon which has been subjected to gas-phase pyrolysis in the presence of a catalyst, carbon baked from pitch, coke, tar or the like, and carbon baked from a polymer such as cellulose, phenolic resin or the like; graphite with which intercalation/deintercalation of lithium ions is possible, such as natural graphite, synthetic graphite, and expanded graphite; and inorganic compounds that can dope/dedope lithium ions, such as WO₂, and MoO₂. These substances may be used solely, or a complex made of a plurality types thereof may be used.

Among these anode active material, use of pyrolytic carbon, pyrolytic carbon which has been subjected to gas-phase pyrolysis in the presence of a catalyst, carbon baked from pitch, coke, tar or the like, carbon baked from a polymer, or graphite (e.g., natural graphite, synthetic graphite, and expanded graphite) allows producing a secondary battery that has preferable battery characteristics, particularly in terms of safety. Particularly, it is preferable that graphite is used for producing a high voltage secondary battery.

In a case where a conductive polymer, carbon, graphite, inorganic compound or the like is used in the anode active material to serve as the anode, a conductive additive material and binding agent may be added to the anode active material.

As the conductive additive material, carbons such as carbon black, acetylene black, and KETJENBLACK, graphite (natural graphite, synthetic graphite) powder, metal powder, metal fiber, and the like can be used. However, the conductive additive material is not limited to these examples.

Moreover, fluorinated polymers such as polytetrafluoroethylene and polyvinylidene fluoride, polyolefin polymers such as polyethylene, polypropylene, and ethylene-propylene-diene terpolymer, and styrene-butadiene rubber may be used as the binding agent. However the binding agent is not limited to these examples.

Ion Conductor and Method of Forming Secondary Battery

As an ion conductor that is included in the secondary battery according to the present invention, a known ion conductor can be used. For instance, an organic electrolytic solution, solid electrolyte (inorganic solid electrolyte, organic solid electrolyte), fused salt or the like can be used. From among these ion conductors, the organic electrolytic solution is suitably used.

The organic electrolytic solution is made of an organic solvent and an electrolyte. Examples of the organic solvent encompass general organic solvents which are aprotic organic solvents: esters such as propylene carbonate, ethylene carbonate, butylene carbonate, diethyl carbonate, dimethyl carbonate, methyl ethyl carbonate, and γ-butyrolactone; tetrahydrofuran; substituted tetrahydrofurans such as 2-methyltetrahydrofuran; ethers such as dioxolane, diethyl ether, dimethoxyethane, diethoxyethane, and methoxyethoxyethane; dimethylsulfoxide; sulfolane; methylsulfolane; acetonitrile; methyl formate; and methyl acetate. These organic solvents may be used solely, or a mixed solvent of two or more organic solvents may be used.

Moreover, examples of the electrolyte encompass lithium salts such as lithium perchlorate, lithium borofluoride, lithium phosphofluoride, lithium arsenate hexafluoride, lithium trifluoromethanesulfonate, lithium halide, and lithium aluminate chloride. One type of the lithium salts may be used or two or more types of the lithium salts may be used in combination. An electrolyte appropriate for the aforementioned solvent is selected, and the two are dissolved together to prepare an organic electrolytic solution. The solvents and electrolytes used to prepare the organic electrolytic solution are not limited to the foregoing examples.

Nitrides, halides, and oxysalts of Li are examples of the inorganic solid electrolyte which is a solid electrolyte. Specific examples encompass: Li₃N, LiI, Li₃N—LiI—LiOH, LiSiO₄, LiSiO₄—LiI—LiOH, Li₃PO₄—Li₄SiO₄, phosphorous sulfide compounds, and Li₂SiS₃.

Examples of the organic solid electrolyte which is a solid electrolyte encompass: a substance including the electrolyte included in the organic electrolyte and a polymer that carries out dissociation of electrolytes; and a substance in which its polymer has an ionizable group.

Examples of the polymer that carries out electrolyte dissociation encompass: a polyethylene oxide derivative or a polymer including this derivative; a polypropylene oxide derivative or a polymer including this derivative; and a phosphoester polymer. Moreover, other methods which add, to the electrolyte: (i) a polymer matrix material containing the aprotic polar solvent, (ii) a mixture of a polymer including an ionizable group and the aprotic electrolyte, or (iii) polyacrylonitrile, are also available. Further, a method that uses both an inorganic solid electrolyte and an organic solid electrolyte is also well known.

In the secondary battery, nonwoven or woven fabric made of material such as electric insulating synthetic resin fiber, glass fiber, or natural fiber; micropore structural material; a molded object of powder such as aluminum, or the like may be used as a separator for retaining the electrolyte fabric. Among these separators, the nonwoven fabric made of synthetic resin such as polyethylene and polypropylene, and the micropore-structured body are preferable in view of attaining a stable quality. Some separators made of the nonwoven fabric of synthetic resin and the micropore-structured body have a function that when the battery abnormally generates heat, the separator melts due to the heat to block electrical connection between the cathode and the anode. In view of safety, such a separator is also suitably used. A thickness of the separator is not particularly limited, and as long as a required amount of electrolyte is retainable and short-circuiting of the cathode and anode can be prevented, the thickness can be any thickness. Generally, a separator having a thickness of not less than 0.01 mm but not more than 1 mm is used, and preferably the thickness is not less than 0.02 mm and not more than 0.05 mm.

The secondary battery can be of any shape: coin-shaped, button-shaped, sheet-shaped, cylinder-shaped, angular-shaped, or the like. In the case of the coin-shaped and button-shaped secondary battery, a general method is to (i) form the cathode and anode in the pellet-shape, (ii) place the cathode and anode in a battery can that has a can structure including a lid, and (iii) caulk (fix) the lid in a state in which an insulating packing is sandwiched between the can and the lid.

On the other hand, in the case of the cylinder-shaped and angular-shaped secondary battery, (i) a sheet-shaped cathode and an anode are inserted in a battery can, (ii) the sheet-shaped cathode and the anode are electrically connected to the secondary battery, (iii) the electrolyte is injected, and v) a sealing plate is sealed via an insulating packing, or the sealing plate is insulated from the battery can by hermetic sealing, to prepare the secondary battery. At this time, a safety valve having a safety component may be used as the sealing plate. The safety component may be, for example, a fuse, bimetal, PTC (positive temperature coefficient) component or the like, so as to serve as an overcurrent preventing component. Moreover, other than the safety valve, methods such as opening a crack in a gasket, opening a crack in the sealing plate, opening a cut in the battery can and, like methods may be used to prevent inner pressure of the battery can from rising. Moreover, an external circuit that incorporates overcharging and overdischarging measures can be used.

The pellet-shaped or sheet-shaped cathode and anode are preferably dried or dehydrated in advance. The cathode and anode can be dried or dehydrated by a general method. For instance, the cathode and anode can be dried by use of, solely or in combination, hot air, vacuum, infrared rays, electron beam, and/or low-moisture air. It is preferable that the temperature is not less than 50° C. but not more than 380° C.

Examples of a method for injecting the electrolyte into the battery can include a method in which injection pressure is applied to the electrolyte and a method in which difference in pressure between negative pressure and atmospheric pressure is utilized. However, how the electrolyte is injected is not limited to these methods. An injected amount of the electrolyte is also not particularly limited, however it is preferable that the amount allows immersing the cathode, the anode, and the separator completely in the electrolyte.

Methods of how to charge and discharge the produced secondary battery include a constant current charge and discharge method, a constant voltage charge and discharge method, and a constant power charge and discharge method; it is preferable to use different methods in accordance with an evaluation purpose of the battery. The foregoing methods can be used solely or in combination to carry out the charging and discharging.

The cathode of the secondary battery according to the present invention includes the cathode active material. Hence, with the secondary battery of the present invention, it is possible to obtain a nonaqueous electrolyte secondary battery that can attain a low solving out of Mn and which is greatly improved in cycle characteristics. Furthermore, it is possible to achieve a nonaqueous electrolyte secondary battery having a low possibility that the discharge capacity decreases.

Although the foregoing description specifically explains a method according to the present invention of producing a secondary battery, it is of course possible to produce, in a known method, a thermoelectric material, a magnetic material, and any other material in various fields, by use of the multiple inorganic compound of the present invention.

Moreover, the present invention includes the following modes. That is, in the multiple inorganic compound according to the present invention, it is preferable that the inorganic compound is an inorganic oxide, the main crystalline phase including a layer-shaped sub crystalline phase, the sub crystalline phase being different in elementary composition from that of the main crystalline phase however including an oxygen arrangement identical to that of the main crystalline phase, each of the main crystalline phase and the sub crystalline phase including at least one metallic element, at least one of the metallic element included in the sub crystalline phase being identical to a metallic element included in the main crystalline phase, the metallic element identical to that included in the sub crystalline phase being formed as a solid solution in the main crystalline phase.

Hence, in a case where the inorganic compound is an inorganic oxide, the main crystalline phase and sub crystalline phase have identical oxygen arrangements, thereby making it possible to have the sub crystalline phase bond with the main crystalline phase with good affinity, by use of the identical oxygen arrangement. As a result, it is possible to have the sub crystalline phase be present on a grain boundary and interface of the main crystalline phase.

In the multiple inorganic compound according to the present invention that has the foregoing configuration, the layer-shaped sub crystalline phase is present in the main crystalline phase in an extremely stable state. According to the invention, such a stable state allows proposing a new design of the multiple inorganic compound. Moreover, the multiple inorganic compound can be used for various purposes.

Moreover, it is preferable that in the multiple inorganic compound according to the present invention, the main crystalline phase and the sub crystalline phase have an intermediate phase at their interface, the intermediate phase including part of the at least one metallic element included in the main crystalline phase and part of the at least one metallic element included in the sub crystalline phase, the part of the at least one metallic element included in the sub crystalline phase being identical to or different from that included in the main crystalline phase.

With such an interface formed in the multiple inorganic compound, it is possible to strongly bond the main crystalline phase with the sub crystalline phase. As a result, the intermediate phase provided between the main crystalline phase and the sub crystalline phase allows achieving a multiple inorganic compound that is further hard to break or the like.

Moreover, it is preferable in the multiple inorganic compound according to the present invention that the sub crystalline phase is one which includes a metallic element and oxygen.

Moreover, it is preferable in the multiple inorganic compound according to the present invention that the sub crystalline phase has a thickness of not less than 1 nm but not more than 100 nm.

If the thickness of the sub crystalline phase is within the foregoing range, it is possible to provide a multiple inorganic compound in which a sub crystalline phase is formed of nano order inside the main crystalline phase. As a result, it is possible to create a new design of the multiple inorganic compound.

Moreover, it is preferable in the multiple inorganic compound of the present invention that the sub crystalline phase has a crystallinity that is detectable by diffractometry.

According to the configuration, it is possible to improve a crystallinity of the sub crystalline phase, and obtain a multiple inorganic compound capable of a higher performance.

Moreover, it is preferable in the method according to the present invention of producing the multiple inorganic compound that the baking causes the compound to decompose, to form a main crystalline phase in which a metallic element formable as a solid solution in the main crystalline phase is included in the main crystalline phase.

As a result, the compound including the metallic element that is to be formed as a solid solution in the main crystalline phase is decomposed by the baking; this causes the metallic element to be formed as a solid solution in the main crystalline phase, whereby allowing the sub crystalline phase to be present inside the main crystalline phase as having a layer shape.

Moreover, it is preferable in the method according to the present invention of producing the multiple inorganic compound that the method further includes: adding, before the baking, (a) an element included in the main crystalline phase as a raw material of the sub crystalline phase, or (b) a compound including an element included in the main crystalline phase and an element that is eliminated from the multiple inorganic compound at a time when the main crystalline phase is baked.

This makes it easier for the metallic element to be formed as a solid solution in the main crystalline phase; as a result, the multiple inorganic compound according to the present invention can be produced more easily.

Moreover, it is preferable in the method according to the present invention of producing the multiple inorganic compound that the baking causes the inorganic compound to decompose, to form a main crystalline phase in which a metallic element formable as a solid solution in the main crystalline phase is included in the main crystalline phase.

As a result, the inorganic compound including the metallic element that is to be formed as a solid solution in the main crystalline phase is decomposed by the baking; this causes the metallic element to be formed as a solid solution in the main crystalline phase, whereby allowing the sub crystalline phase to be present inside the main crystalline phase as having a layer shape.

Moreover, it is preferable in the method according to the present invention of producing a multiple inorganic compound that the method further includes: adding, before the baking, (a) an element included in the main crystalline phase as a raw material of the sub crystalline phase, or (b) a compound including an element included in the main crystalline phase and an element that is eliminated from the multiple inorganic compound at a time when the main crystalline phase is baked.

This makes it easier for the metallic element to be formed as a solid solution in the main crystalline phase; as a result, the multiple inorganic compound according to the present invention can be produced more easily.

A method according to the present invention of producing a multiple oxide is a method of producing a multiple oxide, including: baking (a) a main crystalline phase raw material included in the multiple oxide, the main crystalline phase raw material making up a main crystalline phase including an inorganic oxide, with (b) a compound including at least one type of metallic element that is formable as a solid solution in the main crystalline phase or a simple substance of the metallic element, to produce a multiple oxide wherein the main crystalline phase includes a layer-shaped sub crystalline phase, the sub crystalline phase being different in elementary composition from that of the main crystalline phase however including an oxygen arrangement identical to that of the main crystalline phase, each of the main crystalline phase and the sub crystalline phase including at least one metallic element, at least one of the metallic element included in the sub crystalline phase being identical to a metallic element included in the main crystalline phase, the metallic element identical to that included in the sub crystalline phase being formed as a solid solution in the main crystalline phase.

This method bakes a compound including a metallic element that is present in the main crystalline phase or a simple substance of the metallic element with the main crystalline phase raw material. As a result, a main crystalline phase generated from the main crystalline phase raw material is caused to include the metallic element, and a sub crystalline phase generated from the main crystalline phase raw material and the compound or simple substance also is caused to include the same metallic element.

Furthermore, the main crystalline phase and sub crystalline phase have identical oxygen arrangements. This allows the main crystalline phase and sub crystalline phase to be present with good affinity, thereby making it possible to produce a multiple oxide in which a layer-shaped sub crystalline phase is included in the main crystalline phase.

Moreover, it is preferable in the method according to the present invention of producing the multiple oxide that the baking causes the compound to decompose, to form a main crystalline phase in which a metallic element formable as a solid solution in the main crystalline phase is included in the main crystalline phase.

As a result, the compound including the metallic element that is to be formed as a solid solution in the main crystalline phase is decomposed by the baking; this causes the metallic element to be formed as a solid solution in the main crystalline phase, whereby allowing the sub crystalline phase to be present inside the main crystalline phase as having a layer shape.

Moreover, it is preferable in the method according to the present invention of producing the multiple oxide that the method further includes: adding, before the baking, (a) an element included in the main crystalline phase as a raw material of the sub crystalline phase, or (b) a compound including an element included in the main crystalline phase and an element that is eliminated from the multiple oxide at a time when the main crystalline phase is baked.

This makes it easier for the metallic element to be formed as a solid solution in the main crystalline phase; as a result, the multiple inorganic compound according to the present invention can be produced more easily.

### EXAMPLES

The following description further specifically describes the cathode active material including the multiple inorganic compound according to the present invention, by use of Examples. However, the present invention is not limited to these Examples. Bipolar cells (secondary battery) and cathode active materials obtained in Examples and Comparative Examples were measured to find out the following measurements.

<Operating Cycle Test>

Operating cycle tests were carried out to the obtained bipolar cells under conditions of: a current density of 0.5 mA/cm², a voltage in a range from 4.3 V to 3.2 V, and at temperatures of 25° C. and 60° C. An average value of discharge capacities calculated based on those taken from after the cycle was repeated five times until after the cycle was repeated ten times, served as an (initial discharge capacity), and a discharge capacity maintenance rate obtained by the operating cycle test was evaluated by use of an average value of discharge capacities (discharge capacity after 100 cycles) calculated based on those taken from after 98 cycles were carried out to after 102 cycles were carried out or an average value of discharge capacities (discharge capacity after 200 cycles) calculated based on those taken after 198 cycles were carried out to after 202 cycles were carried out. The discharge capacity maintenance rate was calculated by calculating: {(discharge capacity after 100 cycles)/(initial discharge capacity)}×100, or {(discharge capacity after 200 cycles)/(initial discharge capacity)}×100.

<Photographing HAADF-STEM Image>

The obtained cathode active material powder was set up on resin whose main component is silicon, and the cathode active material was processed, by use of Ga ions, to be cubes of 10 μm. Furthermore, the cathode active material was irradiated with Ga ion beam from one direction, to obtain a thin film sample for STEM-EDX analysis, which sample had a thickness of not less than 100 nm but not more than 150 nm.

With respect to the thin film sample for STEM-EDX analysis, a field-emission electron microscope (HRTEM; manufactured by HITACHI Co. Ltd., Serial Number: HF-2210) was set to have an acceleration voltage of 200 kV, a sample absorption current of 10⁻⁹A, and a beam diameter of 0.7 nmφ, to obtain a HAADF-STEM image.

<Photographing EDX-Element Map>

With respect to the thin film sample for STEM-EDX analysis obtained in the photographing of the STEM image, the field-emission electron microscope (HRTEM; manufactured by HITACHI Co. Ltd., Serial Number HF-2210) was set to have the acceleration voltage of 200 kV, the sample absorption current of 10⁻⁹A, and a beam diameter of 1 nmφ. The thin film sample was irradiated with the beam for 40 minutes, to obtain an EDX-element map.

### Example 1

Zinc oxide was used as zinc source material, and tin (IV) oxide was used as tin source material; these materials were weighed so that a molar ratio of zinc to tin was 2:1. Thereafter, these material were mixed for 5 hours with an automated mortar. Further, the mixed material was baked under air atmosphere for 12 hours at 1000° C., thereby obtaining a baked product. After the baking, the obtained baked product was crushed and thereafter mixed for 5 hours with the automated mortar. This produced a spinel-type compound.

As lithium source material and manganese source material included in the lithium-containing oxide, lithium carbonate and electrolytic manganese dioxide were used, respectively; these materials were weighed so that a molar ratio of lithium to manganese was 1:2. Furthermore, the spinel-type compound was weighed so that the spinel-type compound and the main crystalline phase satisfies x=0.05 in the general formula A. The lithium carbonate, electrolytic manganese dioxide and spinel-type compound were mixed for 5 hours with the automated mortar, and this mixture was pre-baked under the air atmosphere condition for 12 hours at 550° C. An obtained baked product was crushed and thereafter mixed for 5 hours with the automated mortar, thereby obtaining a powder.

The powder was molded to a pellet-shape, and this molded object was baked under air atmosphere condition for 12 hours at 800° C. An obtained baked product was crushed and thereafter mixed for 5 hours with the automated mortar, to obtain the cathode active material.

Moreover, the cathode active material, acetylene black as a conductive additive material, and polyvinylidene fluoride as a binding agent were mixed in a ratio of 80 parts by weight, 15 parts by weight, and 5 parts by weight, respectively, and further this mixture was mixed with N-methylpyrrolidone so that the mixture was prepared as a paste. This paste was applied on an aluminium foil having a thickness of 20 μm, so that a thickness of the paste thus applied became not less than 50 μm but not more than 100 μm. After this paste-applied object was dried, the paste-applied object was punched to be of a disk-shape having a diameter of 15.958 mm, and was vacuum dried. This produced a cathode.

On the other hand, an anode was produced by punching out from a metal lithium foil of a predetermined thickness a disk-shape having a diameter of 16.156 mm. Moreover, a nonaqueous electrolytic solution as the nonaqueous electrolyte was prepared by dissolving LiPF₆, a solute, into a solvent by a proportion of 1.0 mol/l, in which solvent ethylene carbonate and dimethyl carbonate were mixed in a volume ratio of 2:1. As the separator, a porous membrane made of polyethylene having a thickness of 25 μm and a porosity of 40% was used.

The bipolar cell was produced using the foregoing cathode, anode, nonaqueous electrolyte, and separator.

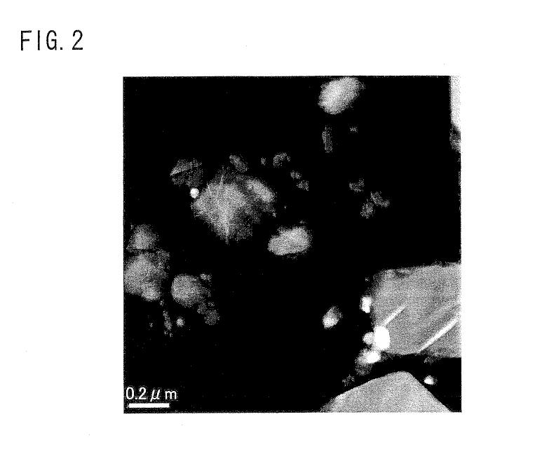

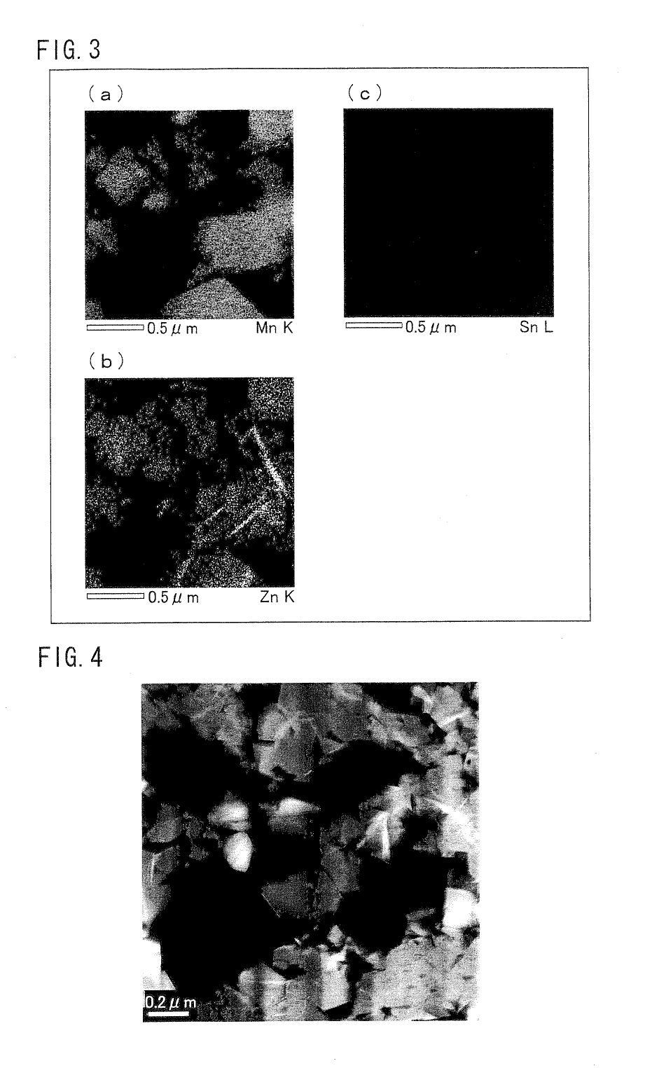

Thereafter, the operating cycle test was carried out to the obtained bipolar cell. A result measured, at 25° C., of the initial discharge capacity and the content maintenance rate attained after the cycle test was carried out is shown in Table 1, and the measured result at 60° C. thereof is shown in Table 2. Moreover, the HAADF-STEM image and the EDX-element map of the obtained cathode active material were photographed. FIG. 2 is a view of the HAADF-STEM image of the cathode active material obtained in Example 1, and FIG. 3 is a view of the EDX-element map of the cathode active material obtained in Example 1.

The HAADF-STEM image analyzes, in a thickness direction, an entire part of a part in which the cathode active material was irradiated with the beam. It is therefore observable from FIGS. 2 and 3 that zinc and tin included in the spinel-type compound is formed as layers, with respect to manganese included in the main crystalline phase. Consequently, it is clearly understood that the spinel-type compound is formed as a layer shape in the cathode active material.

### Example 2

A synthesis similar to Example 1 was carried out, except that the starting material was changed in mixing ratio so that the spinel-type compound and the main crystalline phase satisfied x=0.10 in the general formula A. A bipolar cell was produced in the same method as Example 1. Results of the operating cycle test are shown in Tables 1 and 2.

Moreover, a sample for STEM-EDX analysis was obtained by the same method as Example 1. Thereafter, a HAADF-STEM image was photographed in the same method as Example 1. This image is shown in FIG. 4. Furthermore, an EDX-element map obtained by the same method as Example 1 is shown in FIG. 5. Similarly with. Example 1, it was observed from FIGS. 4 and 5 that the spinel-type compound is formed as having a layer shape in the main crystalline phase of the cathode active material obtained in Example 2.

### Example 3

A synthesis similar to Example 1 was carried out, except that the starting material was changed in mixing ratio so that the spinel-type compound and the main crystalline phase satisfied an equation of x=0.02. A bipolar cell was produced as in the same method as Example 1. Results of the operating cycle test are shown in Tables 1 and 2.

### Comparative Example 1

A synthesis similar to Example 1 was carried out, except that no spinel-type compound was mixed, and just lithium carbonate as the lithium source material and eletrolytic manganese dioxide as the manganese source material were used; further, the mixing ratio of the starting substances were changed so that these materials had the molar ratio of lithium to manganese as 1:2. A bipolar cell was produced in the same method as Example 1. Results of the operating cycle test are shown in Tables 1 and 2.

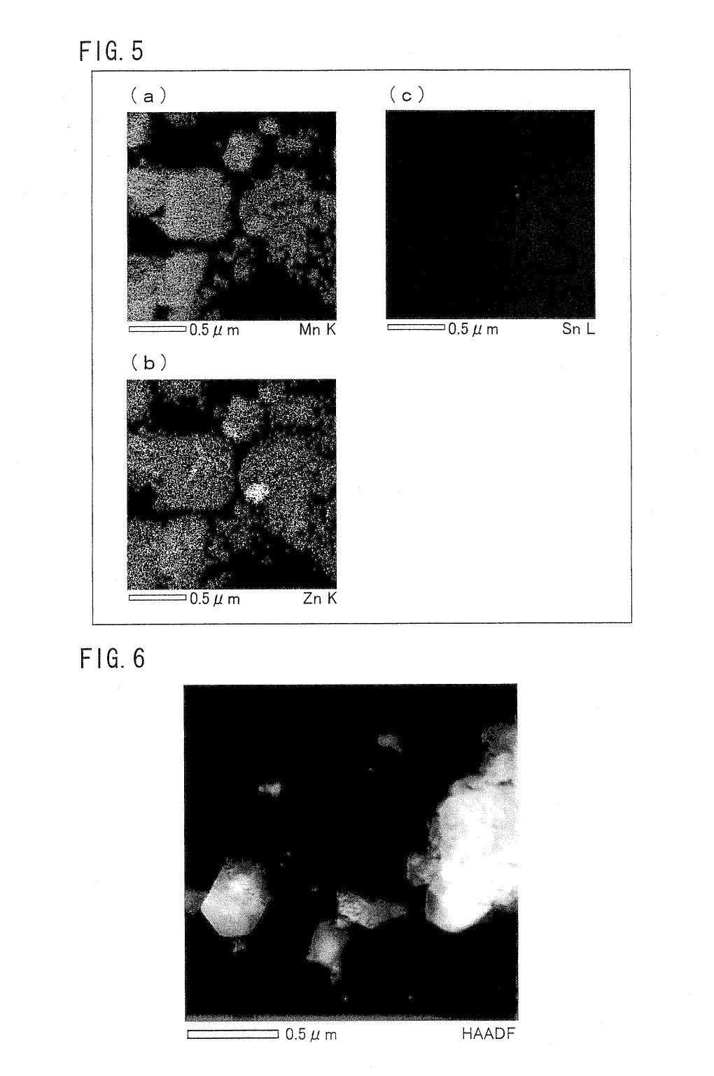

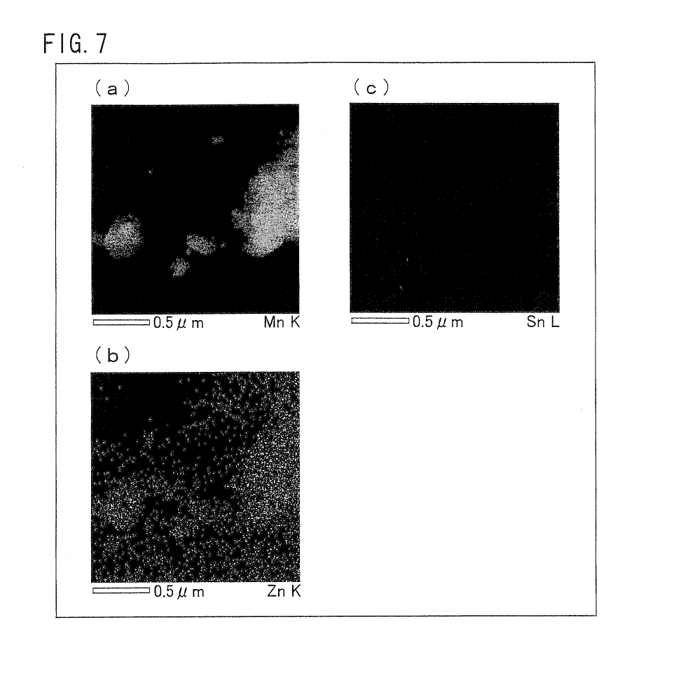

Moreover, a sample for STEM-EDX analysis was obtained by the same method as Example 1. Thereafter, a HAADF-STEM image was photographed in the same method as Example 1. This image is shown in FIG. 6. Furthermore, an EDX-element map obtained by the same method as Example 1 is shown in FIG. 7. Different from Example 1, no layered compound could be observed. Furthermore, a specific element was detected in the EDX analysis at a position in which no element should be present. Hence, the element map of Zn and Sn obtained by the EDX analysis was observed as being one caused by a noise.

TABLE 1
Operating cycle test result at 25° C.

| | Discharge capacity |
|---|---|
| | maintenance rate (%) |
| Example 1 | 90 |
| Example 2 | 91 |
| Example 3 | 87 |
| Comparative | 80 |
| Example 1 | |

TABLE 2
Operating cycle test result at 60° C.

| | Initial discharge | Discharge capacity |
|---|---|---|
| | capacity (mAh/g) | maintenance rate (%) |
| Example 1 | 91 | 73 |
| Example 2 | 76 | 84 |
| Example 3 | 90 | 65 |
| Comparative | 120 | 43 |
| Example 1 | | |

With the bipolar cells of Examples 1 to 3, particularly as clear in the result of the operating cycle test in Table 2 carried out at 60° C., the initial discharge capacity and the discharge capacity maintenance rate both showed a high value.

As described above, a cathode of a secondary battery according to the present invention includes the cathode active material as a cathode material. It was found that, by having the sub crystalline phase be formed inside the main crystalline phase as a layer shape, the cathode active material is improved in cycle characteristics at a time when the secondary battery is of a high temperature. Moreover, the sub crystalline phase formed as a layer shape allows reduction of the degree of decrease in discharge capacity caused by cracking or the like of cathode active material particles, in the cathode active material. Therefore, according to the present invention, it is possible to provide an extremely high performing secondary battery.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

### INDUSTRIAL APPLICABILITY

A cathode active material produced by use of a multiple inorganic compound of the present invention is applicable to a nonaqueous electrolyte secondary battery that is used in portable information terminals, portable electronic apparatuses, small-size power storage apparatuses for home use, electric bicycles using a motor as its power source, electric automobiles, hybrid electric automobiles, and the like.

### REFERENCE SIGNS LIST

1 multiple inorganic compound
1′ multiple oxide
2, 2′ main crystalline phase
3, 3′ sub crystalline phase

What is claimed is:

1. A multiple inorganic compound comprising:
a main crystalline phase including an inorganic compound,
the main crystalline phase including a layer-shaped sub crystalline phase, the sub crystalline phase being different in elementary composition from that of the main crystalline phase however including a non-metallic element arrangement identical to that of the main crystalline phase,
each of the main crystalline phase and the sub crystalline phase including at least one metallic element,
at least one of the metallic element included in the sub crystalline phase being identical to a metallic element included in the main crystalline phase, the metallic element identical to that included in the sub crystalline phase being formed as a solid solution in the main crystalline phase.

2. The multiple inorganic compound according to claim 1, wherein:
the inorganic compound is an inorganic oxide,
the main crystalline phase including a layer-shaped sub crystalline phase, the sub crystalline phase being different in elementary composition from that of the main crystalline phase however including an oxygen arrangement identical to that of the main crystalline phase,
each of the main crystalline phase and the sub crystalline phase including at least one metallic element,
at least one of the metallic element included in the sub crystalline phase being identical to a metallic element included in the main crystalline phase, the metallic element identical to that included in the sub crystalline phase being formed as a solid solution in the main crystalline phase.

3. The multiple inorganic compound according to claim 1, wherein:
the sub crystalline phase has a crystallinity that is detectable by diffractometry.

4. The multiple inorganic compound according to claim 1, wherein:
the main crystalline phase and the sub crystalline phase have an intermediate phase at their interface, the intermediate phase including part of the at least one metallic element included in the main crystalline phase and part of the at least one metallic element included in the sub crystalline phase, the part of the at least one metallic element included in the sub crystalline phase being identical to or different from that included in the main crystalline phase.

5. The multiple inorganic compound according to claim 1, wherein:
the sub crystalline phase is one which includes a metallic element and oxygen.

6. The multiple inorganic compound according to claim 1, wherein:
the sub crystalline phase has a thickness of not less than 1 nm but not more than 100 nm.

7. A cathode active material for use in a nonaqueous secondary battery, comprising:
a multiple inorganic compound including a main crystalline phase including an inorganic compound,
the main crystalline phase including a layer-shaped sub crystalline phase, the sub crystalline phase being different in elementary composition from that of the main crystalline phase however including a non-metallic element arrangement identical to that of the main crystalline phase,
each of the main crystalline phase and the sub crystalline phase including at least one metallic element,
at least one of the metallic element included in the sub crystalline phase being identical to a metallic element included in the main crystalline phase, the metallic element identical to that included in the sub crystalline phase being formed as a solid solution in the main crystalline phase.

8. A thermoelectric conversion material, comprising:
a multiple inorganic compound including a main crystalline phase including an inorganic compound,
the main crystalline phase including a layer-shaped sub crystalline phase, the sub crystalline phase being different in elementary composition from that of the main crystalline phase however including a non-metallic element arrangement identical to that of the main crystalline phase,
each of the main crystalline phase and the sub crystalline phase including at least one metallic element,
at least one of the metallic element included in the sub crystalline phase being identical to a metallic element included in the main crystalline phase, the metallic element identical to that included in the sub crystalline phase being formed as a solid solution in the main crystalline phase.

9. A magnetic material, comprising:
a multiple inorganic compound including a main crystalline phase including an inorganic compound,
the main crystalline phase including a layer-shaped sub crystalline phase, the sub crystalline phase being different in elementary composition from that of the main crystalline phase however including a non-metallic element arrangement identical to that of the main crystalline phase,
each of the main crystalline phase and the sub crystalline phase including at least one metallic element,
at least one of the metallic element included in the sub crystalline phase being identical to a metallic element included in the main crystalline phase, the metallic element identical to that included in the sub crystalline phase being formed as a solid solution in the main crystalline phase.

10. A method of producing a multiple inorganic compound, comprising:
baking (a) a main crystalline phase raw material included in the multiple inorganic compound, the main crystalline phase raw material making up a main crystalline phase including an inorganic compound, with (b) a compound including at least one type of metallic element that is formable as a solid solution in the main crystalline phase or a simple substance of the metallic element, to produce a multiple inorganic compound wherein the main crystalline phase includes a layer-shaped sub crystalline phase, the sub crystalline phase being different in elementary composition from that of the main crystalline phase however including a non-metallic element arrangement identical to that of the main crystalline phase, each of the main crystalline phase and the sub crystalline phase including at least one metallic element, at least one of the metallic element included in the sub crystalline phase being identical to a metallic element included in the main crystalline phase, the metallic element identical to that included in the sub crystalline phase being formed as a solid solution in the main crystalline phase.

11. The method according to claim 10, wherein:
the inorganic compound is an inorganic oxide,
the multiple inorganic compound being produced by baking (a) a main crystalline phase raw material included in the multiple inorganic compound, the main crystalline phase raw material making up a main crystalline phase including an inorganic oxide, with (b) a compound including at least one type of metallic element that is formable as a solid solution in the main crystalline phase or a simple substance of the metallic element, to produce a multiple inorganic compound wherein the main crystalline phase includes a layer-shaped sub crystalline phase, the sub crystalline phase being different in elementary composition from that of the main crystalline phase however including an oxygen arrangement identical to that of the main crystalline phase, each of the main crystalline phase and the sub crystalline phase including at least one metallic element, at least one of the metallic element included in the sub crystalline phase being identical to a metallic element included in the main crystalline phase, the metallic element identical to that included in the sub crystalline phase being formed as a solid solution in the main crystalline phase.

12. The method according to claim 10, wherein:
the baking causes the compound to decompose, to form a main crystalline phase in which a metallic element formable as a solid solution in the main crystalline phase is included in the main crystalline phase.

13. The method according to claim 10, further comprising:
adding, before the baking, (a) an element included in the main crystalline phase as a raw material of the sub crystalline phase, or (b) a compound including an element included in the main crystalline phase and an element that is eliminated from the multiple inorganic compound at a time when the main crystalline phase is baked.
